(19) United States
(12) Patent Application Publication
(10) Pub. No.: US 2024/0247336 A1
(43) Pub. Date: Jul. 25, 2024

(54) HIGH-EFFICIENCY GOLD RECOVERY BY ADDITIVE-INDUCED SUPRAMOLECULAR POLYMERIZATION OF CYCLODEXTRIN

(71) Applicant: Northwestern University, Evanston, IL (US)

(72) Inventors: Huang Wu, Evanston, IL (US); Yu Wang, Evanston, IL (US); James Fraser Stoddart, Evanston, IL (US)

(21) Appl. No.: 18/420,277

(22) Filed: Jan. 23, 2024

Related U.S. Application Data
(60) Provisional application No. 63/481,178, filed on Jan. 23, 2023.

(51) Int. Cl. C22B 11/00; C22B 3/22; C22B 3/44; C22B 5/02; C22B 7/00; C22B 11/02

(52) U.S. Cl. CPC C22B 11/046; C22B 3/22; C22B 3/44; C22B 5/02; C22B 7/001; C22B 7/007; C22B 11/025

(57) ABSTRACT

Disclosed herein are composition and methods for gold recover based on precisely controlling the reciprocal transformation and instantaneous assembly of the second-sphere coordinated adducts formed between cyclodextrin and gold anions optionally in the presence of an additive.

### CROSS-REFERENCE TO RELATED APPLICATIONS

This application is related to, claims priority to, and incorporates herein by reference for all purposes U.S. Provisional Patent Application No. 63/481,178, filed Jan. 23, 2023.

### BACKGROUND

Gold, an indispensable element in human society, is widely used in currency and jewelry manufacture,¹ electronic fabrication,² medicine production,³ and chemical synthesis.⁴ Gold mining, however, is known notoriously to be one of the most environmentally destructive industries in today's world. Massive amounts of cyanide⁵ and mercury⁶ are used to extract gold from ores each year, resulting in enormous waste streams contaminated with lethal cyanide and heavy metals, along with colossal amounts of carbon emissions and excessive energy consumption. In order to develop sustainable technologies for gold production and recovery, many alternative methods,⁷ based upon the selective extraction or adsorption of gold from leaching solutions, have been developed. These methods include leaching electronic waste (e-waste) and gold ores with a single organic⁸⁻¹²/inorganic¹³ extraction reagent, or specific combinations^{14,15} of extraction reagents and organic solvents, not to mention the adsorption of ionic gold complexes with metal-organic frameworks^{16,17} and polymers¹⁸⁻²⁰. As an alternative approach to extraction and adsorption, selective and rapid co-precipitation²¹⁻²⁴ processes based on second-sphere coordination^{25,26} have proven increasingly popular for metal separations given their significant advantages, e.g., simple operation, case of industrialization, minimal energy consumption, and zero hazardous emission.

First-sphere coordination,²⁷ advanced in the early part of the 20th century by Nobel Laureate in Chemistry, Alfred Werner, refers to the coordinative bonding interactions between first-coordination sphere ligands and transition metals. Under the umbrella of supramolecular^{28,29} and host-guest^{30,31} chemistry, the investigation of second-sphere coordination,³²⁻³⁴ which involves the noncovalent interactions between the first-sphere ligand and a macrocyclic molecule as the second-sphere ligand. In this context, many well-crafted macrocyclic receptors, e.g., crown ethers,³² cyclodextrins,^{35,36} calixarenes,³⁷ cucurbiturils,³⁸ and others^{39,40} have emerged as promising second-sphere coordination ligands capable of modulating the chemical and physical properties of transition metal complexes. These macrocycles exhibit highly specific recognition for particular metal cationic complexes, including those containing Rh⁺,⁴¹ Ru²⁺,⁴² Gd³⁺,⁴³ and Yb³⁺,⁴⁴ as well as serve as anion receptors⁴⁵⁻⁴⁷ for negatively-charged metal complexes, such as [ReQ₄]⁻,⁴⁸ [CdCl₄]²⁻,⁴⁹ [PtCl₆]²⁻,⁵⁰ polyoxometalates⁵¹ and others.⁵² The precise control of the assembly and reciprocal transformation of these second-sphere coordinated adducts, however, remains challenging. Some of the second-sphere coordinated adducts exhibit⁵³ unique crystallinity, a property which paves the way for using second-sphere coordination to recycle precious metals from e-waste. Employing this protocol, we have separated^{54,55} gold from ores where α-cyclodextrin acts preferentially as a second-sphere coordinator for hydrated potassium tetrabromoaurate. When it comes to practical gold recovery, this protocol, however, still suffers from several limits, including the fact that (i) a high content of gold ([KAuBr₄]>6 mM) in the leaching solution is required, (ii) additional potassium ions are mandatory, (iii) a high concentration of acid in the leaching solution prevents the formation of co-precipitates, (iv) gold-recovery efficiency is below 80% when performed at room temperature, and (v) the cost of α-cyclodextrin is relatively high. Hence, the development of more efficient and economic gold separation technology aligned with practical gold recovery is significant and necessary.

### SUMMARY

Disclosed herein is high-efficiency gold recovery by additive-induced supramolecular polymerization of cyclodextrin. An aspect of the technology provides for adducts formed from cyclodextrin, gold halide anions, and additives. The gold halide anion occupies a space between primary faces of the cyclodextrin and the additive occupies a space between secondary faces of the cyclodextrin and/or within an internal cavity of the cyclodextrin. The cyclodextrin tori may be arranged in a head-to-head and tail-to-tail manner extending along an axis and forming a one-dimensional supramolecular polymer. The gold halide anion may be [AuBr₄]⁻. The cyclodextrin may be β-cyclodextrin. In some instances, the gold halide anion is [AuBr₄]⁻ and the cyclodextrin is β-cyclodextrin.

Additives for use in the present technology include those that are hydrophobic and have a binding affinity for cyclodextrin. This allows for participation in the co-assembly process. The additives should be size matched to the cavity of the cyclodextrin and preferably are able to share the cavity with the gold halide anion. This allows for the formation of the one-dimensional supramolecular nanostructures. As used herein, size-matched refers to an additives ability to partially or completely fit within the cavity of the cyclodextrin. Additives with high boiling points are preferred when it comes to improving the stability of the cocrystals. The additive may have a boiling point greater than 50° C., 60° C., 70° C., 80° C., 90° C., 100° C., 110° C., 120° C., 130° C., 140° C., 150° C., 160° C., 170° C., 180° C., 190° C., 200° C., 210° C., 220° C., 230° C., 240° C., or 250° C. Suitably, the additive may have a boiling point greater than 50° C., 60° C., 70° C., 80° C., 90° C., 100° C., 110° C., 120° C., 130° C., 140° C., 150° C., 160° C., 170° C., 180° C., 190° C., 200° C., 210° C., 220° C., 230° C., 240° C., or 250° C. and less than 400° C., 350° C., or 300° C. The additive may be a straight or branched, saturated or unsaturated organic molecular optionally comprising a heteroatom, i.e., a non-carbon or non-hydrogen atom. Exemplary heteroatoms include, without limitation, oxygen, nitrogen, sulfur, phosphorus, fluorine, chlorine, bromine, and iodine. Exemplary additives include ethers, arenes, alkylarenes, haloalkanes, and alkanes. Exemplary additives used in the Examples include dibutyl carbitol, isopropyl ether, benzene, toluene, chloroform, dichloromethane, or hexane.

Another aspect of the technology provides for a method for preparing an adduct. The method may comprise contacting a cyclodextrin, a gold halide anion, and an additive in solution under conditions suitable for formation of the adduct. Suitably, the conditions for formation of the adduct may include room temperature and/or atmospheric pressure. The time for adduct formation may be short, e.g. from seconds to minutes. The additive may be added to a comprising the cyclodextrin and gold halide anion. In some instances, the additive is added to the solution at a percentage between 0.05% v/v and 5.0% v/v, optionally between 0.05% v/v and 4.5% v/v, between 0.05% v/v and 4.0% v/v, between 0.05% v/v and 3.5% v/v, between 0.05% v/v and 3.0% v/v, between 0.05% v/v and 2.5% v/v, between 0.05% v/v and 2.0% v/v, between 0.05% v/v and 1.5% v/v, between 0.05% v/v and 1.0% v/v, or between 0.05% v/v and 0.5% v/v. In some instances, the molar ratio of cyclodextrin to gold halide anion is between 0.5 and 5.0, optionally between 1.0 and 4.0, between 1.5 and 3.5, or between 2.0 and 3.0. In some instances, the concentration of gold halide anion is between 0.01 mM and 5.0 mM, optionally between 0.02 mM and 4.0 mM, between 0.03 mM and 3.0 mM, between 0.04 mM and 2.5 mM, or between 0.05 mM and 2.0 mM.

Another aspect of the technology is a method for recovering gold. The method may comprise contacting a gold-bearing material with a hydrogen halide to form a gold halide anion, contacting the gold halide anion with a cyclodextrin and an additive to form an adduct, and reducing the adduct. The adduct may be formed by any of the methods described herein. An exemplary method for preparing the gold halide anion is to contact the gold-bearing material with HBr and H₂O₂. The adduct may be reduced by any suitable reducing agent, such as N₂H₄·H₂O. After reducing the adduct, the cyclodextrin may be recycled.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1. shows host-guest interactions between β-CD and KAuBr₄. (a) Schematic illustration of the recognition of [AuBr₄]⁻ anions facilitated by second-sphere coordination with β-CD. (b) ¹H NMR Spectra (600 MHZ, D₂O containing 0.5 M DBr, [β-CD]=2.5×10⁻⁴ M, [KAuBr₄]=1.5×10⁻³ M, 298 K) of β-CD and KAuBr₄⊂β-CD. (c) Changes in mole fractions for β-CD and KAuBr₄⊂β-CD as a function of the KAuBr₄-to-β-CD ratio during the ¹H NMR titration. (d) ¹H NMR Titration isotherm created by monitoring changes in the chemical shift of H-5 upon adding 0-6 molar equivalents of KAuBr₄ to an aqueous solution of β-CD. (c) Theoretical and experimental high-resolution mass spectra of [AuBr₄]⁻⊂β-CD in aqueous solutions. (f) The solid-state superstructure of [AuBr₄]⁻⊂β-CD. (g) Intermolecular binding iso-surface of [AuBr₄]⊂β-CD. Solvent molecules in crystal superstructure have been omitted for the sake of clarity.

FIG. 2. shows additive-induced supramolecular polymerization between β-CD, KAuBr₄, and a collection of additives. (a) Visual display of the selective co-precipitation between β-CD and KAuBr₄ upon adding additives. (b) Effect of adding different additives on the yield of gold-bearing co-precipitates. (c) Effect of the amount of dibutyl carbitol (DBC) on the yield of gold-bearing co-precipitates. (d) FTIR Spectra of DBC, KAuBr₄⊂β-CD, and the KAuBr₄·DBC⊂2β-CD co-precipitate obtained by adding DBC to an aqueous solution of KAuBr₄⊂β-CD complex. (c) Powder X-ray diffraction patterns of the KAuBr₄·DBC⊂2β-CD co-precipitate, compared with a simulated pattern derived from X-ray crystallographic data for HAuBr₄·DBC⊂2β-CD cocrystal. (f, g) SEM Images of the KAuBr₄·DBC⊂2β-CD microcrystals prepared by adding DBC to an aqueous solution of KAuBr₄⊂β-CD.

FIG. 3. shows solid-state superstructure and intermolecular binding iso-surface of the HAuBr₄·DBC⊂2β-CD cocrystal. It illustrates the mechanism of additive-induced supramolecular polymerization. (a) Capped-stick and space-filling representations of different views of the HAuBr₄·DBC⊂2β-CD quaternary complex, showing the packing mode and dimensions of the complex. (b) Intermolecular binding iso-surface between β-CD and DBC, β-CD and [AuBr₄], DBC and [AuBr₄]⁻, respectively. (c) Capped-stick and space-filling representation of the one-dimensional nanostructure extending along the c-axis, in which the β-CD tori form a continuous channel occupied by alternating DBC and [AuBr₄]⁻ anions. Solvent molecules have been omitted for the sake of clarity. (d) Schematic illustration of the mechanism of additive-induced supramolecular polymerization after adding various additives to the solution of β-CD and [AuBr₄]⁻ anions.

FIG. 4. shows cocrystal-to-cocrystal transformation of the ternary adducts. It shows the possible reason for different additives leading to variable gold-recovery efficiencies. (a) Schematic illustration of the cocrystal-to-cocrystal transformation upon loss of additives. (b) Solid-state superstructure and the intermolecular binding iso-surface of the HAuBr₄·2(iPr₂O)⊂2β-CD cocrystal, dubbed as cocrystal A, obtained by adding iPr₂O into the solution of β-CD and [AuBr₄]⁻ followed by standing at room temperature for 12 h. (c) Solid-state superstructure and the intermolecular binding iso-surface of 0.5(HAuBr₄)⊂2β-CD cocrystal, dubbed as cocrystal B, obtained by adding iPr₂O into the solution of β-CD and [AuBr₄]⁻ followed by standing at room temperature for 3 days. Solvent molecules have been omitted for the sake of clarity. (d) Changes in powder X-ray diffraction patterns of the HAuBr₄·2(iPr₂O)⊂2β-CD cocrystal over time, demonstrating that the cocrystal undergoes a phase transformation from cocrystals A to B.

FIG. 5. shows gold recovery from electronic scrap based on additive-induced supramolecular polymerization. (a) Schematic diagram of the selective recovery of gold from gold-bearing electronic waste using β-CD and additives. (b) Effect of the β-CD-to-[AuBr₄]⁻ ratio on the gold-recovery efficiency. (c) Effect of the CD's size on the gold-recovery efficiency at different molar ratios. (d) Effect of changing the counter cation associated with the [AuBr₄]⁻ anion on the gold-recovery efficiency. (e) XPS Spectra of HAuBr₄·DBC⊂2β-CD cocrystals, and the microcrystals were obtained by adding β-CD and DBC to a gold-bearing mixture solution. (f) Powder X-ray diffraction patterns of HAuBr₄·DBC⊂2β-CD cocrystals and the microcrystals obtained by adding β-CD and DBC to a gold-bearing mixture solution. (g) Effect of changes in concentration of [AuBr₄]⁻ anions on gold-recovery efficiency, when adding β-CD and DBC to a gold-bearing mixture solution. (h) SEM-EDS Elemental maps of the HAuBr₄·DBC⊂2β-CD microcrystals obtained by adding β-CD and DBC to a gold-bearing mixture solution.

FIG. 6. shows ¹H NMR Spectra (600 MHZ, D₂O containing 0.5 M DBr, 25° C.) of β-CD (0.25 mM) titrated with KAuBr₄ (25 mM).

FIG. 7. shows (a) Titration isotherm created by monitoring changes in the chemical shift of H-5 in β-CD, caused by the stepwise addition of KAuBr₄ at 25° C. The line is the result of curve fitting using a 1:1 receptor-substrate binding model. (b) Mole fractions are based on the fitting results, indicating that the concentration of the free β-CD undergoes a continuous decrease, while the concentration of KAuBr₄⊂β-CD complex undergoes a continuous increase.

FIG. 8. illustrates X-Ray single-crystal superstructure of the KAuBr₄⊂β-CD complex. (a, b) Capped-stick and space-filling representations of the solid-state superstructures of KAuBr₄⊂β-CD. (c) Ball- and capped-stick representation of the K—O interactions, showing that each K⁺ ion forms eight sets of [K⁺···O] coordinative bonds with four glucose residues and two water molecules. The K⁺ ions are located on both the primary and secondary faces of β-CD tori and interact with four β-CD tori. (d) Capped-stick representation of the packing of the β-CD tori, showing that the two primary faces and two secondary faces of adjacent β-CD tori adopt a displaced staggered stack. (c) Capped-stick and space-filling representation of the crystal packing of β-CD and KAuBr₄, showing the relative positions of K⁺ cations, [AuBr₄]⁻ anions, and the β-CD tori. The “1°” represents the primary face and the “2°” represents the secondary face of β-CD. Solvent molecules have been omitted for the sake of clarity.

FIG. 9. shows ¹H NMR Spectra (600 MHZ, D₂O containing 0.5 M DBr, 25° C.) of β-CD (0.5 mM) titrated with K₂PdBr₄ (100 mM).

FIG. 10. shows (a) Titration isotherm created by monitoring changes in the chemical shift of H-5 in β-CD, caused by the stepwise addition of K₂PdBr₄ at 25° C. The line is the result of curve fitting using a 1:1 receptor-substrate binding model. (b) Mole fractions are based on the fitting results, indicating that the concentration of the free β-CD undergoes a continuous decrease, while the concentration of K₂PdBr₄CB-CD complex undergoes a continuous increase.

FIG. 11. shows ¹H NMR Spectra (600 MHZ, D₂O containing 0.5 M DBr, 25° C.) of β-CD (0.15 mM) titrated with a saturated K₂PtBr₄ (11.34 mM) aqueous solution. In order to avoid the error caused by volume dilution, we did not continue to increase the number of equivalents of the K₂PtBr₄ during the titration.

FIG. 12. shows (a) Titration isotherm created by monitoring changes in the chemical shift of H-4 in β-CD, caused by the stepwise addition of K₂PtBr₄ at 25° C. The line is the result of curve fitting using a 1:1 receptor-substrate binding model. (b) Mole fractions are based on the fitting results, indicating that the concentration of the free β-CD undergoes a continuous decrease, while the concentration of K₂PtBr₄CB-CD complex undergoes a continuous increase.

FIG. 13. shows (a) SEM images of the HAuBr₄·DBC⊂2β-CD microcrystals obtained by adding DBC to an aqueous solution of [AuBr₄]⁻⊂β-CD complex. (b-f) SEM-EDS Elemental maps of the HAuBr₄·DBC⊂2β-CD microcrystals, showing all the component elements well distributed in the microrods.

FIG. 14. shows thermogravimetric analysis (TGA) of (a) KAuBr₄·DBC⊂2β-CD and (b) the co-precipitates obtained by adding different additives to the aqueous solutions of β-CD and [AuBr₄]⁻ anion.

FIG. 15. shows X-Ray single-crystal superstructure of the HAuBr₄·DBC⊂2β-CD cocrystal. (a) Capped-stick and space-filling representation of the solid-state superstructure of [AuBr₄]=2β-CD, showing that [AuBr₄]⁻ is located between the primary faces of the two β-CD tori. (b) Ball- and capped-stick representation of the solid-state superstructure of DBC·H₂O⊂2β-CD, showing that DBC is located between the secondary faces of the two β-CD tori. (c) The top view of the solid-state superstructure of DBC·H₂O⊂2β-CD, showing noncovalent interactions between DBC, H₂O and two β-CD tori. (d) Ball-and-stick representation of the solid-state superstructure and noncovalent interactions between [AuBr₄]⁻ and DBC. (c) Capped-stick and space-filling representation of the packing of HAuBr₄·DBC⊂2β-CD in the b-c plane, in which the β-CD tori form continuous nanotubes extending along the c axis occupied by alternating DBC and [AuBr₄]⁻ anions. (f) Capped-stick and space-filling representation of the packing of HAuBr₄·DBC⊂2β-CD in the a-b plane, showing relative dispositions of adjacent one-dimensional nanotubes. The “1°” represents the primary face and the “2°” represents the secondary face of β-CD. Solvent molecules have been omitted for the sake of clarity.

FIG. 16. shows powder X-ray diffraction patterns of microcrystals obtained by adding hexane to aqueous solutions of β-CD and [AuBr₄]⁻ anion. (a) Simulation derived from the single-crystal X-ray crystallographic data for cocrystal A. (b-c) The synthetic microcrystals obtained by adding hexane to the solution of [AuBr₄]⁻⊂β-CD after allowing them to stand in the mother liquid for 0.5, 2.0, 24 and 48 h. (f) Simulation derived from the single-crystal X-ray crystallographic data for cocrystal B. This phenomenon demonstrates the fact that the microcrystals change from cocrystal A to cocrystal B over time.

FIG. 17. shows powder X-ray diffraction patterns of microcrystals obtained by adding CH₂Cl₂ to aqueous solutions of β-CD and [AuBr₄]⁻ anion. (a) Simulation derived from the single-crystal X-ray crystallographic data for cocrystal A. (b-d) The synthetic microcrystals obtained by adding CH₂Cl₂ to the solution of [AuBr₄]⁻⊂β-CD after allowing them to stand in the mother liquid for 0.5, 2.0, and 24 h. (c) Simulation derived from the single-crystal X-ray crystallographic data for cocrystal B. This phenomenon demonstrates the fact that the microcrystals change from cocrystal A to cocrystal B over time.

FIG. 18. shows powder X-ray diffraction patterns of microcrystals obtained by adding CHCl₃ to aqueous solutions of β-CD and [AuBr₄]⁻ anion. (a) Simulation derived from the single-crystal X-ray crystallographic data for cocrystal A. (b-c) The synthetic microcrystals obtained by adding CHCl₃ to the solution of [AuBr₄]⁻⊂β-CD after allowing them to stand in the mother liquid for 0.5, 2.0, 24, and 48 h. (f) Simulation derived from the single-crystal X-ray crystallographic data for cocrystal B. This phenomenon demonstrates the fact that the microcrystals change from cocrystal A to cocrystal B over time.

FIG. 19. shows X-Ray photoelectron spectra of the microcrystals obtained by adding CH₂Cl₂ to aqueous solutions of β-CD and [AuBr₄]⁻ anion, followed by filtration, washing with H₂O and air drying. (a) Full scan spectrum of the microcrystals, (b) narrow scan of Cl 2p.

FIG. 20. shows X-Ray photoelectron spectra of the microcrystals obtained by adding CHCl₃ to aqueous solutions of β-CD and [AuBr₄]⁻ anion, followed by filtration, washing with H₂O and air drying. (a) Full scan spectrum of the microcrystals, (b) narrow scan of Cl 2p.

FIG. 21. shows ¹H NMR Spectra (600 MHZ, D₂O containing 0.5 M DBr, 25)° C. of Y-CD (0.25 mM) titrated with KAuBr₄ (100 mM).

FIG. 22. shows (a) Titration isotherm created by monitoring changes in the chemical shift of H-3 in γ-CD, caused by the stepwise addition of KAuBr₄ at 25° C. The line is the result of curve fitting using a 1:1 receptor-substrate binding model. (b) Mole fractions are based on the fitting results, indicating that the concentration of the free Y-CD undergoes a continuous decrease, while the concentration of KAuBr₄CY-CD complex undergoes a continuous increase.

FIG. 23. illustrates the effect of changes in concentration of [AuBr₄]⁻ on gold-recovery efficiency, when adding 0.1% (v/v) of DBC to the aqueous solution of KAuBr₄⊂β-CD complex. The concentration of HBr was 1 M in all aqueous solutions.

FIG. 24. shows fourier-transform infrared (FTIR) spectra of (a) HAuBr₄·DBC⊂2β-CD cocrystals, and (b) the cocrystals obtained by adding β-CD and DBC to a gold-bearing leaching solution of electronic waste.

FIG. 25. shows SEM images of the HAuBr₄·DBC⊂2β-CD microcrystals obtained by adding β-CD and DBC to a leaching solution of electronic waste, illustrating (a-d) the rod-like microstructures, and (e, f) some large crystals are made up of nanorods.

FIG. 26. illustrates gold-recovery flow diagram, which is proposed based on the additive-induced supramolecular polymerization of β-CD and [AuBr₄]⁻ anions. Light orange arrows and boxes indicate the flow direction for the recovery of gold.

### DETAILED DESCRIPTION OF THE INVENTION

Developing an eco-friendly, efficient, and highly selective gold-recovery technology is urgently needed in order to maintain sustainable environments and improve the utilization of resources. Here we report a de novo additive-induced gold recovery paradigm based on precisely controlling the reciprocal transformation and instantaneous assembly of the second-sphere coordinated adducts formed between β-cyclodextrin and tetrabromoaurate anions. The additives initiate a rapid assembly process by co-occupying the binding cavity of β-cyclodextrin along with the tetrabromoaurate anions, leading to the formation of supramolecular polymers that precipitate from aqueous solutions as cocrystals. The efficiency of gold recovery reaches 99.8% when dibutyl carbitol is deployed as the additive. This cocrystallization is highly selective for square-planar tetrabromoaurate anions. In a laboratory-scale gold-recovery protocol, over 94% of gold in electronic waste was recovered at gold concentrations as low as 9.3 ppm. This simple protocol constitutes a promising paradigm for the sustainable recovery of gold, featuring reduced energy consumption, low cost inputs, and the avoidance of environmental pollution.

Disclosed herein are high-efficiency gold recovery methods utilizing β-cyclodextrin. The composition and methods described herein provide an environmentally benign, highly efficient, and thoroughly selective processes for gold recovery. As further described herein, contacting a macrocycle with gold halide anions creates adducts where the gold halide anions are reversibly bound to the outer surface of the macrocycle by non-covalent interactions, allowing of the efficient production of precipitates that may be separated from their gold bearing source material. The Examples demonstrate the trapping of metal halide ions, such as [AuBr₄]⁻ anions, as their acids and alkali salts with a cyclodextrin macrocycle facilitated by the multiple weak [Au—X···H—C] (X=Cl/Br) hydrogen bonding and [Au—X···C—O] (X=Cl/Br) ion-dipole interactions. A gold recovery efficiency of 99.8% is achieved when dibutyl carbitol is used as the additive.

An “adduct” is a new chemical species AB, each molecular entity of which is formed by direct combination of two separate molecular entities A and B in such a way that there is change in connectivity, but no loss, of atoms within the moieties A and B. Stoichiometries other than 1:1 are also possible, such as 2:1, 3:1, 4:1 and so forth.

The adduct is formed from a metal halide anion non-covalently bound to the outer surface of a macrocycle. Macrocycles are a cyclic macromolecular or a macromolecular cyclic portion of a macromolecule. A molecule of high relative molecular mass, the structure of which essentially comprises the multiple repetition of units derived, actually or conceptually, from molecules of low relative molecular mass.

The term “cyclodextrin” refers to any of the known cyclodextrins such as unsubstituted cyclodextrins containing from six to twelve glucose units, especially, alpha-cyclodextrin, beta-cyclodextrin, gamma-cyclodextrin and/or their derivatives and/or mixtures thereof. The alpha-cyclodextrin consists of six glucose units, the beta-cyclodextrin consists of seven glucose units, and the gamma-cyclodextrin consists of eight glucose units arranged in donut-shaped rings. The specific coupling and conformation of the glucose units give the cyclodextrins rigid, conical molecular structures with hollow interiors of specific volumes. The “lining” of each internal cavity is formed by hydrogen atoms and glycosidic bridging oxygen atoms; therefore, this surface is fairly hydrophobic. The unique shape and physical chemical properties of the cavity enable the cyclodextrin molecules to absorb inorganic or organic molecules or parts of inorganic or organic molecules which can fit into the cavity.

In some embodiments, the molecular receptor is cyclodextrin derivatives or modified cyclodextrins. The derivatives of cyclodextrin consist mainly of molecules wherein some of the OH groups are converted to OR groups. The cyclodextrin derivatives can, for example, have one or more additional moieties that provide additional functionality, such as desirable solubility behavior and affinity characteristics. Examples of suitable cyclodextrin derivative materials include methylated cyclodextrins (e.g., RAMEB, randomly methylated beta-cyclodextrins), hydroxyalkylated cyclodextrins (e.g., hydroxypropyl-cyclodextrin and hydroxypropyl-gamma-cyclodextrin), acetylated cyclodextrins (e.g., acetyl-gamma-cyclodextrin), reactive cyclodextrins (e.g., chlorotriazinyl-CD), branched cyclodextrins (e.g., glucosyl-beta-cyclodextrin and maltosyl-cyclodextrin), sulfobutyl-cyclodextrin, and sulfated cyclodextrins.

Cyclodextrin derivatives are also disclosed in U.S. Pat. No. 6,881,712 and include, e.g., cyclodextrin derivatives with short chain alkyl groups, such as methylated cyclodextrins and ethylated cyclodextrins, where R is a methyl or an ethyl group; those with hydroxyalkyl substituted groups, such as hydroxypropyl cyclodextrins and/or hydroxyethyl cyclodextrins, where R is a —CH₂—CH(OH)—CH₃ or a —CH₂CH₂—OH group; branched cyclodextrins such as maltose-bonded cyclodextrins; cationic cyclodextrins such as those containing 2-hydroxy-3-(dimethylamino)propyl ether, where R is —CH₂—CH(OH)—CH₂—N(CH₃)₂ which is cationic at low pH; quaternary ammonium, e.g., 2-hydroxy-3-(trimethylammonio)propyl ether chloride groups, where R is —CH₂—CH(OH)—CH₂N⁺ (CH₃)₃Cl⁻; anionic cyclodextrins such as carboxymethyl cyclodextrins, cyclodextrin sulfates, and cyclodextrin succinylates; amphoteric cyclodextrins such as carboxymethyl/quaternary ammonium cyclodextrins; cyclodextrins wherein at least one glucopyranose unit has a 3-6-anhydro-cyclomalto structure, e.g., the mono-3-6-anhydrocyclodextrins, as disclosed in “Optimal Performances with Minimal Chemical Modification of Cyclodextrins”, F. Diedaini-Pilard and B. Perly, The 7th International Cyclodextrin Symposium Abstracts, April 1994, p. 49 said references being incorporated herein by reference; and mixtures thereof. Other cyclodextrin derivatives are disclosed in U.S. Pat. No. 3,426,011, Parmerter et al., issued Feb. 4, 1969; U.S. Pat. Nos. 3,453,257; 3,453,258; 3,453,259; and 3,453,260, all in the names of Parmerter et al., and all issued Jul. 1, 1969; U.S. Pat. No. 3,459,731, Gramera et al., issued Aug. 5, 1969; U.S. Pat. No. 3,553,191, Parmerter et al., issued Jan. 5, 1971; U.S. Pat. No. 3,565,887, Parmerter et al., issued Feb. 23, 1971; U.S. Pat. No. 4,535,152, Szejtli et al., issued Aug. 13, 1985; U.S. Pat. No. 4,616,008, Hirai et al., issued Oct. 7, 1986; U.S. Pat. No. 4,678,598, Ogino et al., issued Jul. 7, 1987; U.S. Pat. No. 4,638,058, Brandt et al., issued Jan. 20, 1987; and U.S. Pat. No. 4,746,734, Tsuchiyama et al., issued May 24, 1988; all of said patents being incorporated herein by reference. In some embodiments, the molecular receptor is β-cyclodextrin.

The metal halide anion comprises a noble metal. In some embodiments, the metal halide anion is a square-planar anion such as [MX₄]⁻ where M is a noble metal, such as Au, and X is a halide. The metal halide anion may comprise other noble metals such as Pt or Pd. Each halide may be the same, such as for [AuBr₄]⁻. In other embodiments, the metal halide anion may comprise two or more different halides. In some embodiments, the metal halide anion is provided with a counter anion such as H⁺ or metal cation, such as an alkali cation.

Superstructures and crystalline compositions may be formed from adducts described herein. A “crystalline composition” is a material whose constituents are arranged in a highly ordered microscopic structure, forming a crystal lattice. A “superstructure” is a material having additional structure superimposed upon a given crystalline material, supramolecular assembly, or other well-defined substructure.

A “supramolecular assembly” is a well-defined complex of molecules held together by noncovalent bonds. Suitably, supramolecular assemblies may have well defined order in one, two, or three dimensions. The supramolecular assemblies described herein between the gold halide anion and the outer surface of the macrocycle may include hydrogen bonds and/or ion-dipole interactions, such as [Au—X···H—C] and [Au—X···C═O], respectively.

In some embodiments, the well-defined substructure may be a supramolecular polymer. “Supramolecular polymers” are polymeric arrays of monomer units, held together by reversible and directional non-covalent interactions, such as hydrogen bonds. The resulting materials therefore maintain their polymeric properties in solution. The directions and strengths of the interactions are tuned so that the array of molecules behaves as a polymer. The high reversibility of the non-covalent bonds ensures that supramolecular polymers are always formed under conditions of thermodynamic equilibrium. The lengths of the chains are directly related to the strength of the non-covalent bond, the concentration of the monomer, and the temperature.

The compositions described herein may be used for the isolation and recovery of gold from gold-bearing materials. A “gold-bearing material” is material comprised of gold atoms, regardless of oxidation state. Exemplary gold-bearing materials include, without limitation, ores, metal mixtures, or post-consumer products.

The term “metal mixture” refers to two or more elements from Groups IA, IIA, IB to VIIIB, the lanthanide series and actinide series of the periodic table. An example of a metal mixture is Au and Pt.

The term “post-consumer product” refers to any man-made product for consumption, bartering, exchange or trade. Examples of “post-consumer product” include a jewelry item, an electronics item, precious metal products, and coins, among others.

The term “jewelry item” includes any aesthetic item that includes as one component a precious metal. Examples of a jewelry item include a ring, a bracelet and a necklace, among others.

The term “electronics item” refers to a product that includes at least one circuit for conducting electron flow. Examples of an electronics item include a computer, a monitor, a power supply, an amplifier, and a preamplifier, a digital to analog converter, an analog to digital converter, and a phone, among others.

The term “precious metal product” includes a partially purified form or a purified form of a noble metal, such as gold, platinum, palladium and silver. Examples of a precious metal include a powder, ingot, or bar of gold, silver, platinum, among others. As used herein, “partially-purified form” refers to a form having from about 10% to about 75% of the pure form of a noble metal. As used herein, “purified form” refers to a form having greater than about 75% of the pure form of a noble metal.

The term “coin” refers to any pressed object composed of a pure metal, mixed metal or metal alloy that can be used as a currency, a collectable, among other uses. As used herein, “pure metal” refers to a single metal of at least 95% or greater purity. As used herein “mixed metal” refers to two or more metals. As used herein “metal alloy” refers to a mixture or solid solution of a metal with at least one other element.

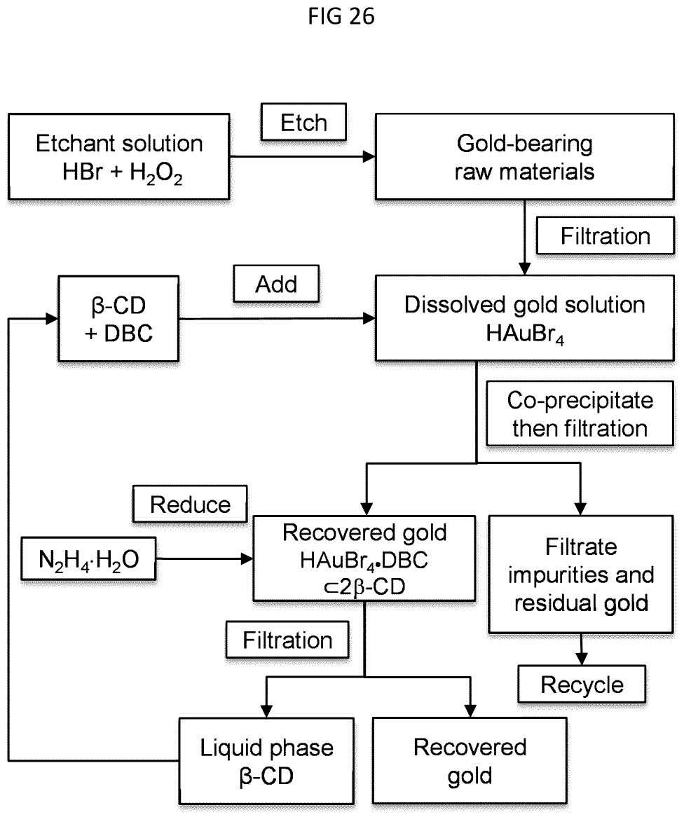

A method for isolating and recovering gold from gold-bearing materials was developed based upon the selective co-precipitation of metal halide anions non-covalently bound to the outer surface of macrocycles. Referring to FIG. 26, which is a gold recovery diagram proposed based on the additive-induced supramolecular polymerization of β-CD and [AuBr₄]⁻ anions. The gold of the gold-bearing material reacts with the hydrogen halide to form the product HAuX₄.

In some embodiments, not all of gold-bearing material can be dissolved in a gold halide solution. As a result, some solid remnants of gold-bearing material (whether or not including gold) can persist. In such aspects, it may be desirable to include a filtration step to remove the solid remnants prior to subsequent processing. The resultant filtrate may be processed as described above to obtain the isolated gold.

The method for isolating and recovering gold from gold-bearing materials has several applications. In one aspect, the method can be applied to isolating gold from gold-bearing material, wherein the gold-bearing material is selected from an ore, a metal mixture, or a post-consumer product. The foregoing examples of isolating gold from gold-bearing materials are not limited to the foregoing materials. The specific etching and leaching process for dissolving gold from gold-bearing materials results in formation of a specific gold-halide compound that can be recovered in the form of a complex with the macrocycle, thereby rendering the method suitable for recovering gold from each of these particular applications as well as other gold-bearing materials.

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### EXAMPLES

Herein, we demonstrate a de novo additive-induced gold separation paradigm based on precisely controlling the reciprocal transformation of the second-sphere coordinated adducts formed between β-CD and [AuBr₄]⁻ anions. Mechanistic investigations reveal that the additives drive rapid assembly of β-CD and [AuBr₄]⁻ anions by forcing the [AuBr₄]⁻ anions to move from the inner cavity to the primary faces of two β-CD tori, while the additives occupy the space between the secondary faces of the two β-CD tori, thus forming one-dimensional supramolecular polymers that precipitate from aqueous solutions as cocrystals. A wide range of common organic solvents can be employed as additives. Solvents with high boiling points provide higher gold-recovery efficiencies. A gold-recovery efficiency of 99.8% has been achieved when dibutyl carbitol is used as the additive. The rapid cocrystallization is highly selective for [AuBr₄]⁻ anions, while no precipitate is observed when using metal cations along with other structurally similar anions, such as [PdBr₄]²⁻ and [PtBr₄]²⁻. A laboratory-scale gold-recovery protocol, aligned with an attractive strategy for the practical recovery of gold metal, has been established, wherein 94% of gold is recovered directly from a leaching solution of gold-bearing scrap at gold concentrations as low as 9.3 ppm.

### Encapsulation KAuBr₄ by β-Cyclodextrin

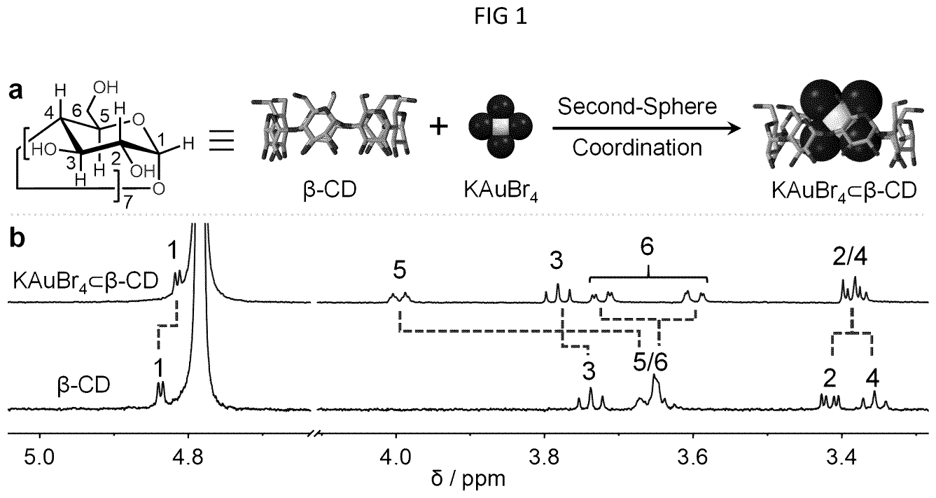

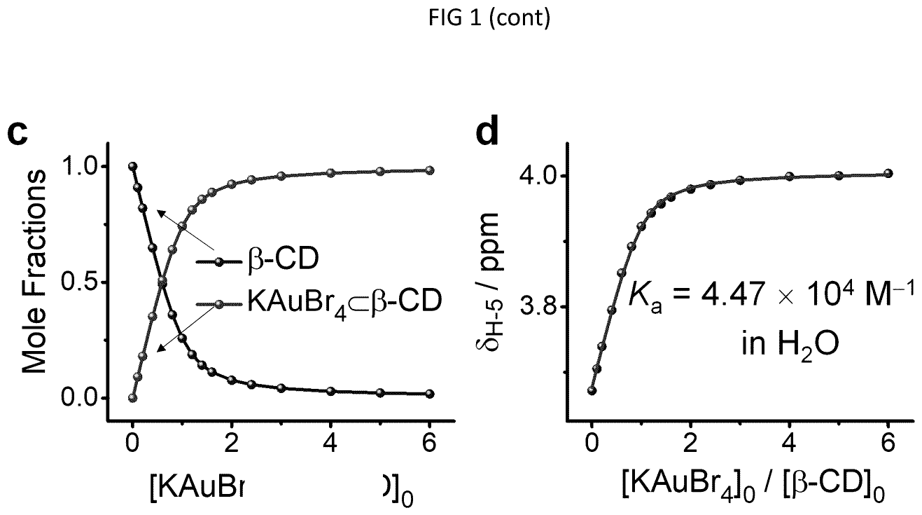

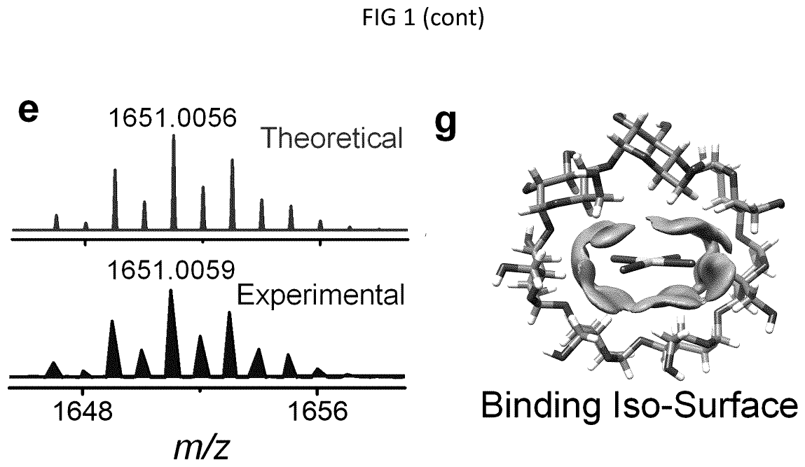

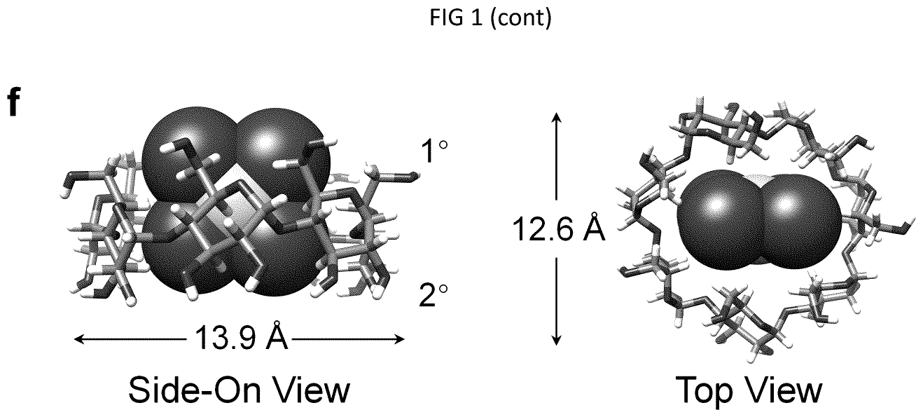

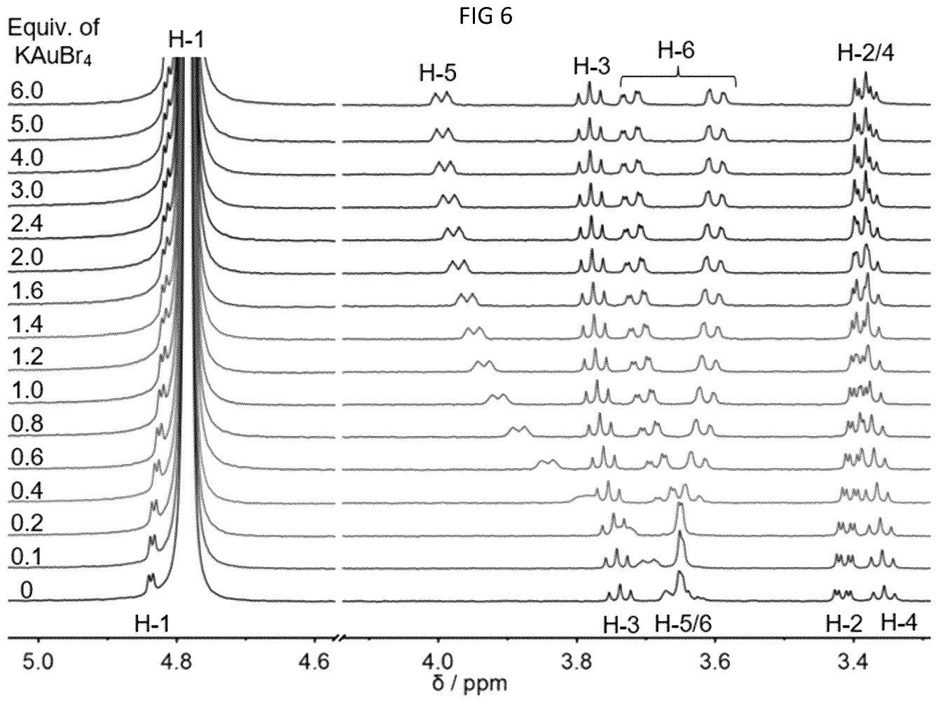

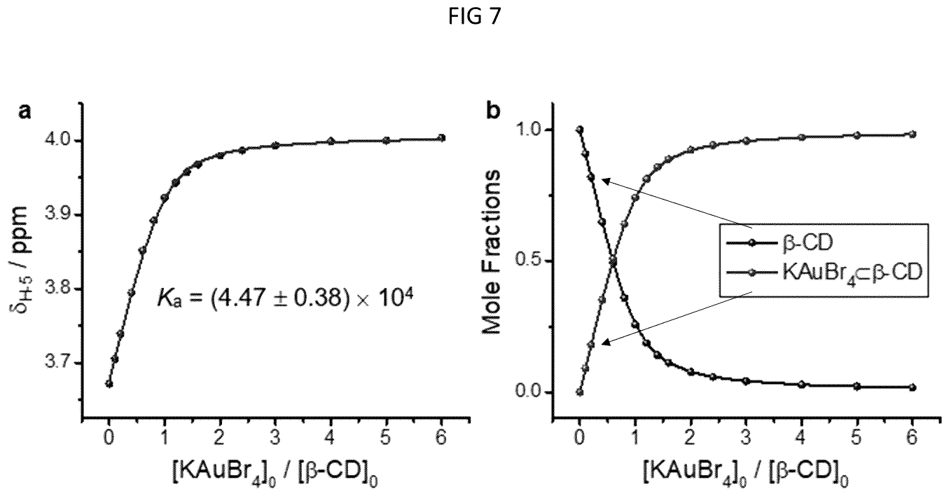

Second-sphere coordination (FIG. 1a) of KAuBr₄ with β-CD in aqueous solutions was investigated by ¹H NMR spectroscopy. After adding an excess of KAuBr₄ into a D₂O solution of β-CD, all the protons on the β-CD show (FIG. 1b) notable changes in their chemical shifts. The resonances for protons H-1 and H-2 on the D-glucopyranosyl residues of β-CD show upfield shifts (Δδ=−0.03 and −0.03 ppm for H-1 and H-2), while the resonances for protons H-3, H-4, and H-on the D-glucopyranosyl residues undergo downfield shifts (Δδ=0.05, 0.03 and 0.33 ppm for H-3, H-4, and H-5, respectively). Proton H-5 exhibits the largest downfield shift, while the resonance for proton H-6 separates into two sets of peaks, indicating that the [AuBr₄]⁻ anions are located near the primary face of β-CD. The binding affinity between β-CD and KAuBr₄ in D₂O was determined (FIG. 1c and FIGS. 6-7) by ¹H NMR titration. By tracking the changes in the chemical shift of H-5, the binding constant (Kₐ) between the [AuBr₄]⁻ anion and β-CD was determined (FIG. 1d) to be 4.47×10⁴M⁻¹. The corresponding ΔG° value was calculated to be −6.3 kcal mol 1. Additionally, a strong peak with an m/z value of 1651.0059 was observed in the high-resolution mass spectrum, corresponding to a 1:1 complex [[AuBr₄]⁻⊂β-CD]. Its isotopic pattern matches (FIG. 1e) well with the theoretical one, strongly supporting the formation of the host-guest complex in aqueous solutions.

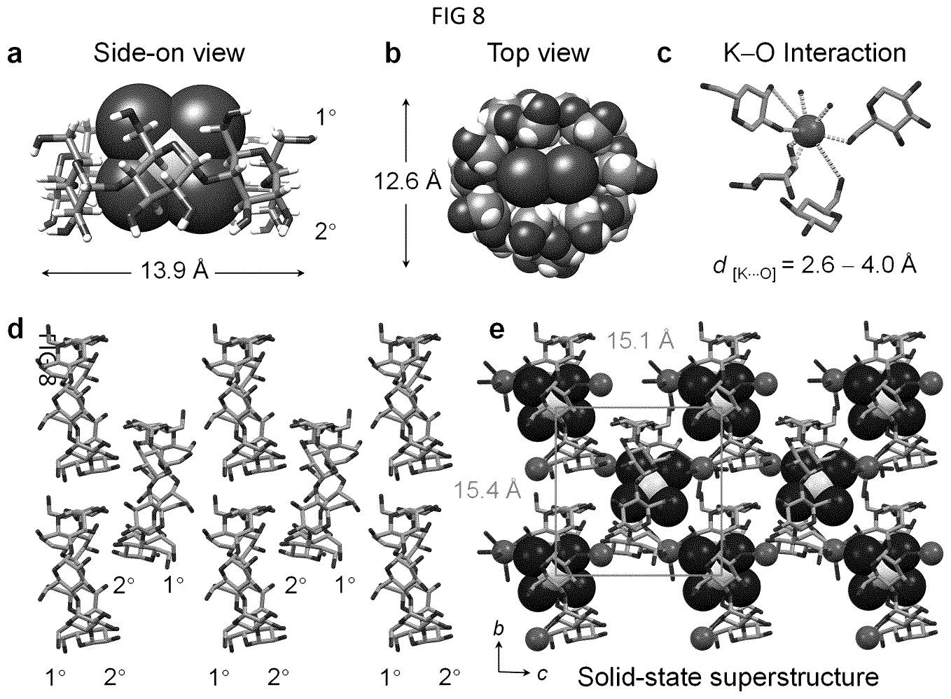

The solid-state superstructure of the 1:1 complex was determined unambiguously by single-crystal X-ray diffraction analysis. Brown single crystals were obtained by slowly cooling an aqueous solution of KAuBr₄ and β-CD from 90° C. to room temperature over 6 h. The [AuBr₄]⁻ anion, which is encapsulated (FIG. 1f) inside the cavity of β-CD, is located closer to the primary face (1°) of β-CD than to its secondary face (2°). The β-CD tori are distorted (FIG. 1f) elliptically and elongated along the [AuBr₄]⁻ plane. The lengths of the major and minor axes for the distorted β-CD tori are 13.9 and 12.6 Å, respectively. In the superstructure of the [AuBr₄]⁻⊂β-CD complex, five of the H-5 protons on β-CD interact (FIG. 8) closely with bromine atoms. The [C—H···Br-Au] distances (Table 1) range from 3.0 to 3.4 Å. It is for this reason that the H-5 protons show the largest change in their chemical shift in the ¹H NMR spectra. Three of the H-6 protons on β-CD also have close contacts with the bromine atoms in the anion. The [C—H···Br-Au] distances (Table 1) are 3.2-3.4 Å. These observations suggest that the [AuBr₄]⁻⊂β-CD complex is stabilized by multiple weak [C—H···Br-Au] hydrogen bonding interactions, aided and abetted by a hydrophobic effect overall. These noncovalent interactions were visualized (FIG. 1g) by an independent gradient model (IGM) analysis. All the results confirm the formation of second-sphere coordinated KAuBr₄⊂β-CD adducts in the solution and solid states.

### Additive-Induced Supramolecular Polymerization

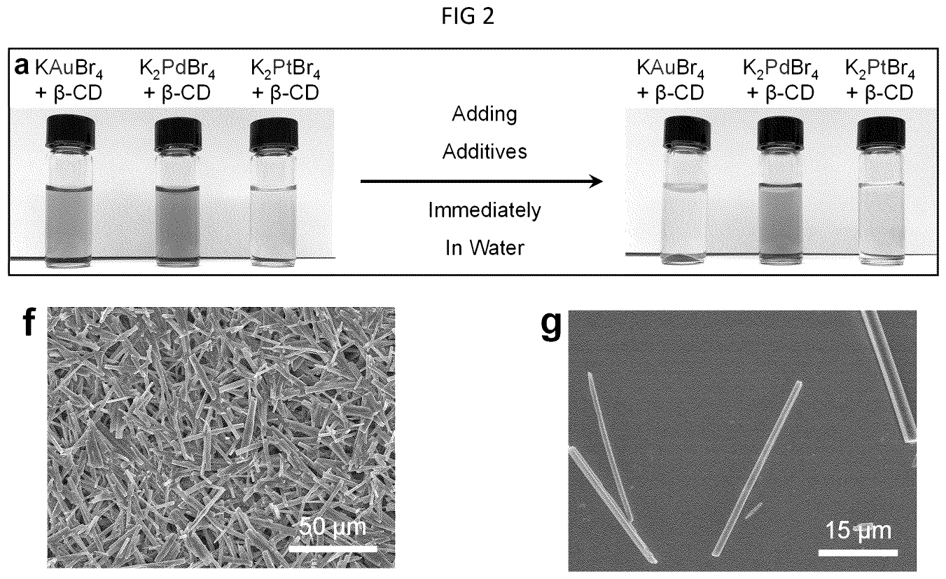

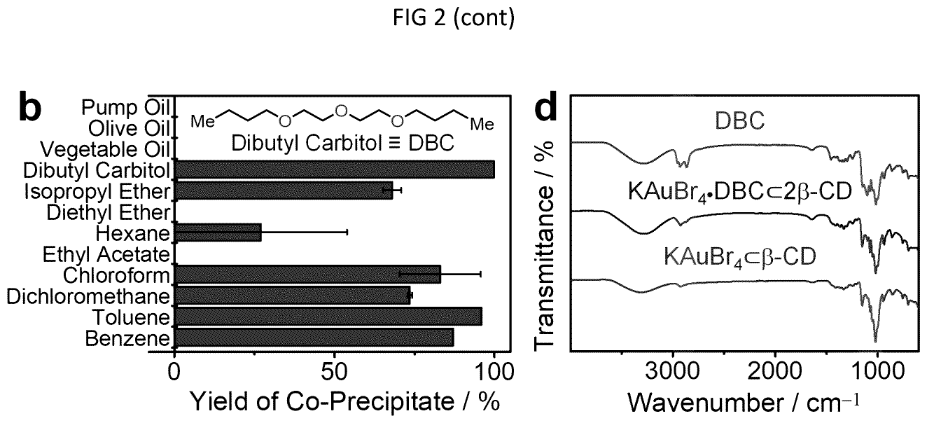

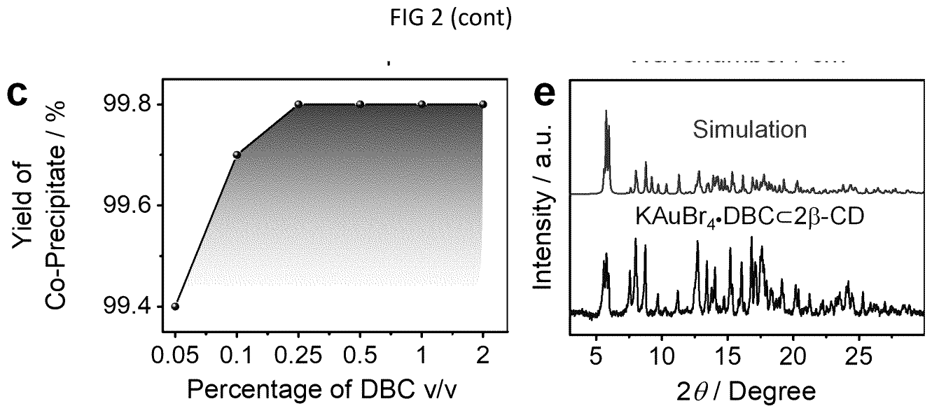

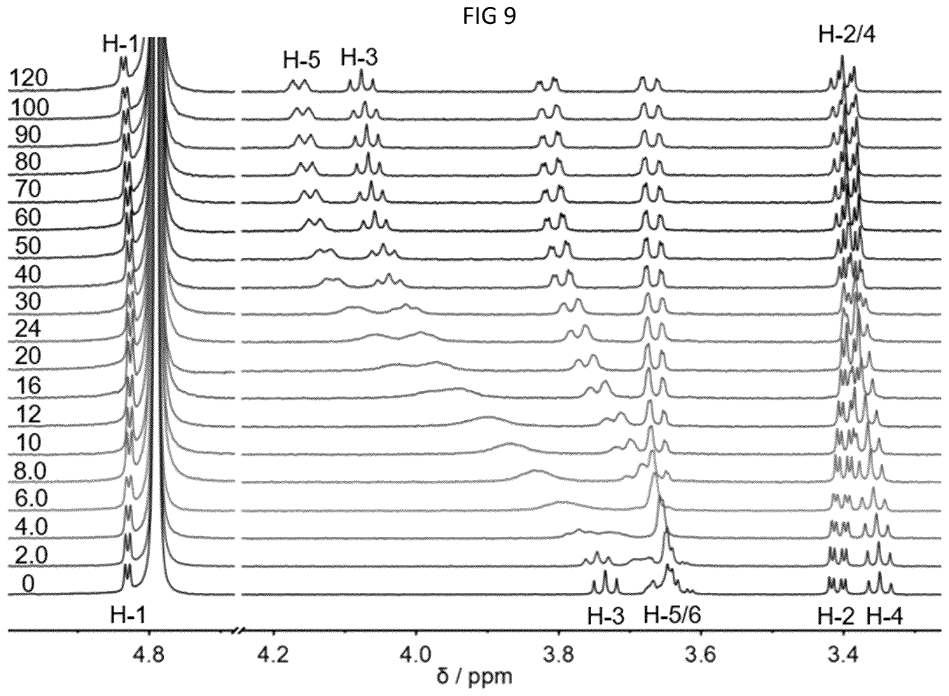

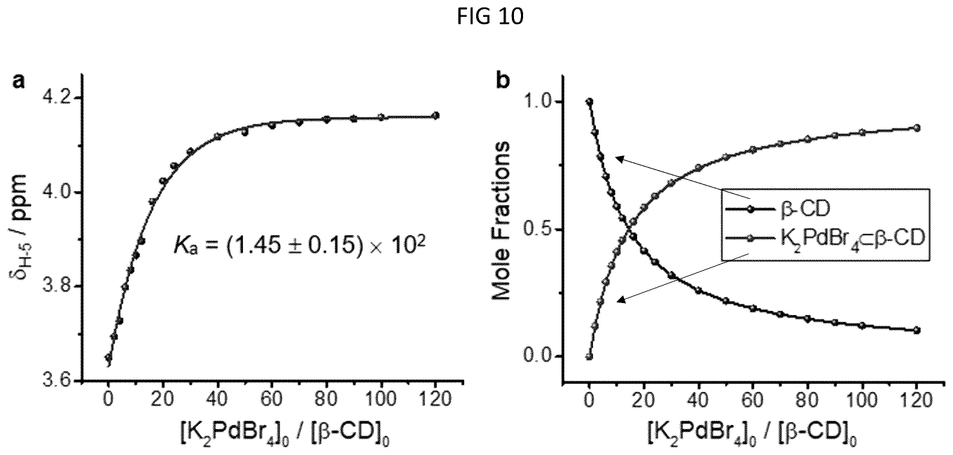

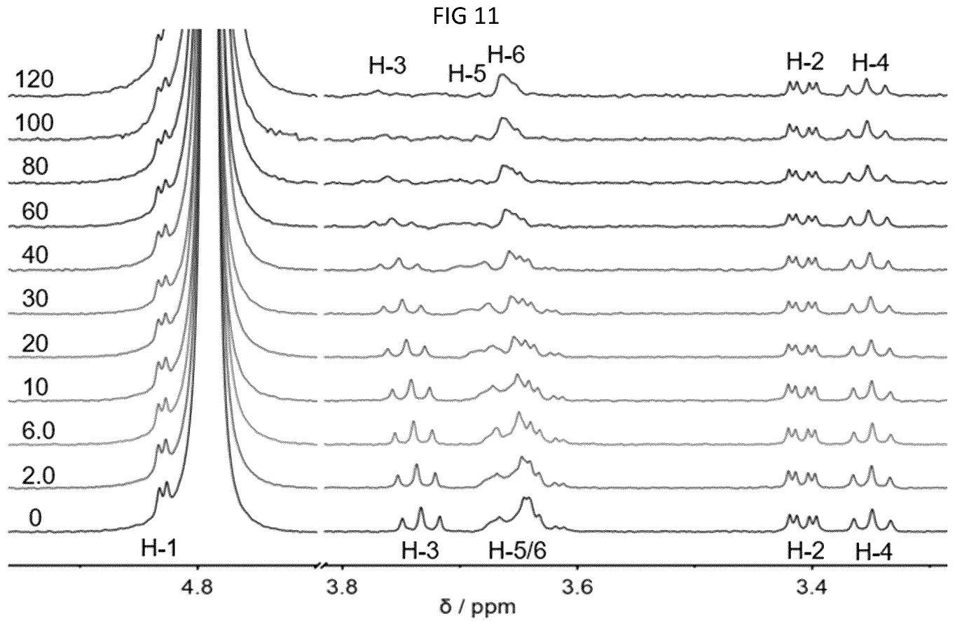

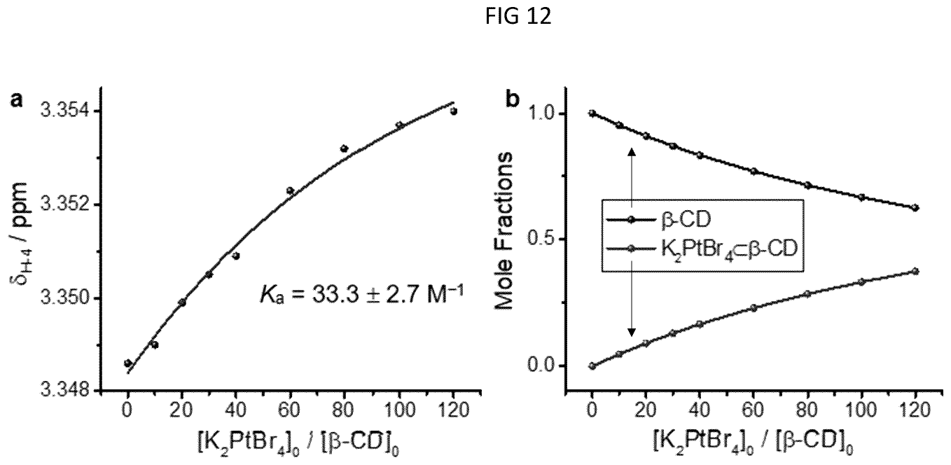

Upon adding a trace amount of common organic solvents, which serve as additives, to a 1 M HBr aqueous solution of the KAuBr₄⊂β-CD complex, brown co-precipitates form immediately. (FIG. 2a) On the contrary, after mixing the same additives and β-CD with the aqueous solutions of K₂PdBr₄ or K₂PtBr₄, which have lower binding affinities (1.45×10² and 33.3 M⁻¹, respectively, FIGS. 9-12) with β-CD, no precipitation is observed (FIG. 2a). This observation establishes the fact that a trace amount of organic solvent can induce selective co-precipitation between KAuBr₄ and β-CD, laying the foundation for developing a simple and effective gold-recovery technology. In order to verify the generality of this additive-induced co-precipitation behavior, various organic solvents and oils were added (FIG. 2b) to aqueous solutions of the KAuBr₄⊂β-CD complex. Dibutyl carbitol (DBC), isopropyl ether (iPr₂O), hexane, dichloromethane (CH₂Cl₂), chloroform (CHCl₃), benzene and toluene can induce co-precipitation, while no precipitate was observed when diethyl ether, ethyl acetate, and other oils were used as additives. In order to quantify the yield of gold co-precipitates, UV-Vis absorption spectroscopy was performed. The characteristic absorption peaks for [AuBr₄]⁻ at 381 and 253 nm were used to determine the concentration of [AuBr₄]⁻ in the filtrates. The efficiencies of gold recovery for different samples were calculated based on the initial and residual concentrations of the [AuBr₄]⁻ anions in the aqueous solutions. We observed gold-recovery efficiencies ranging (FIG. 2b) from 27.0 to 99.8%, depending on the additives. It is worth noting that when DBC was used as the additive, the [AuBr₄]⁻ anions were almost entirely precipitated from aqueous solutions with a gold-recovery efficiency of 99.8%. This efficiency is much higher than that (78.3%) obtained in a previous method⁵⁴ using α-CD. Gold-recovery efficiency was also optimized with respect to the amount of the additive. The results indicate that 0.1% (v/v) of DBC enables (FIG. 2c) a high gold precipitation yield of 99.7%. These observations suggest that DBC is the best candidate for gold recovery amongst all additives tested.

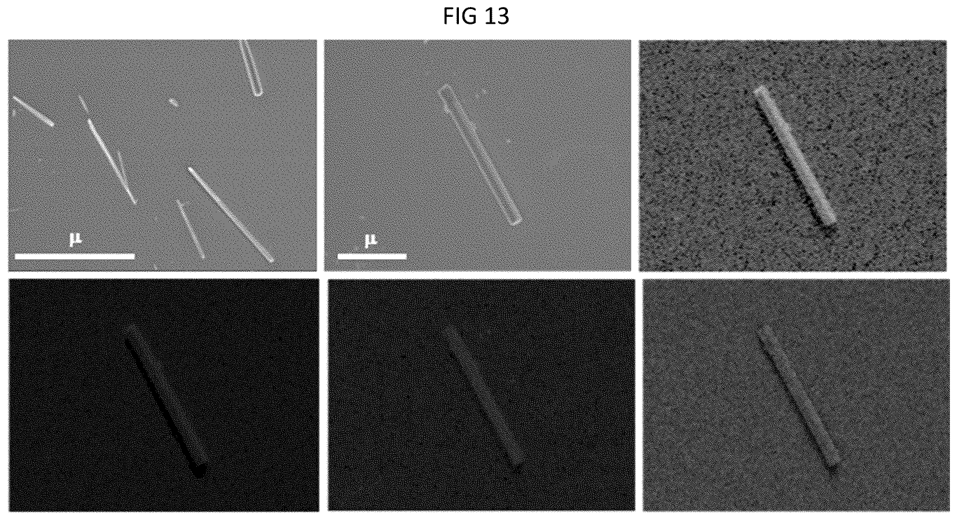

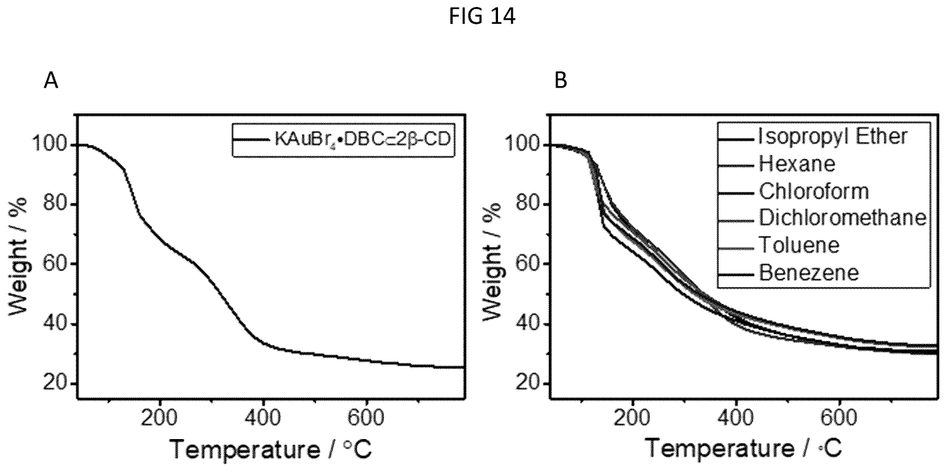

Filtration of the suspension, which was obtained upon the addition of DBC to an aqueous solution of the KAuBr₄⊂β-CD complex, led to the isolation of a brown solid. The Fourier transform infrared (FTIR) spectrum of this solid reveals (FIG. 2d) sharp vibrational bands for the KAuBr₄⊂β-CD complex at 1021 and 1152 cm⁻¹, in addition to the characteristic vibration bands for DBC at 2864 and 2925 cm⁻¹. These data confirm the formation of a ternary adduct between β-CD, KAuBr₄, and DBC-namely, KAuBr₄·DBC⊂2β-CD. In order to investigate the crystallinity of the KAuBr₄·DBC⊂2β-CD adduct, powder X-ray diffraction (PXRD) analysis was performed. The PXRD pattern shows (FIG. 2e) a series of sharp diffraction peaks, indicating that the co-precipitate is a highly crystalline material. In the scanning electron microscopic (SEM) images (FIGS. 2f-2g) of the air-dried KAuBr₄·DBC⊂2β-CD suspension, a plethora of angular rod-like microstructures with diameters in the range of several micrometers and lengths up to hundreds of micrometers were observed. SEM-Equipped energy-dispersive X-ray spectroscopic (SEM-EDS) elemental maps uncover (FIG. 13) a homogeneous distribution of the elements of carbon, oxygen, bromine, and gold throughout the microrods, confirming the formation of KAuBr₄·DBC⊂2β-CD adducts. The thermogravimetric analysis (TGA) profile for the KAuBr₄·DBC⊂2β-CD co-precipitate reveals (FIG. 14) that it begins to suffer mass loss at temperatures around 100° C., most likely because of the loss of crystalline water. Significant decomposition occurs around 160 and 280° C., arising from halide release and the breakdown of β-CD. Finally, over 70 wt % of the original mass of the co-precipitate was lost at 800° C. The TGA traces for the co-precipitates obtained by adding other additives behavior in a similar fashion (FIG. 14) to that of the KAuBr₄·DBC⊂2β-CD adduct over the temperature range from 40 to 800° C., indicating they have similar components.

### Mechanism of Additive-Induced Supramolecular Polymerization

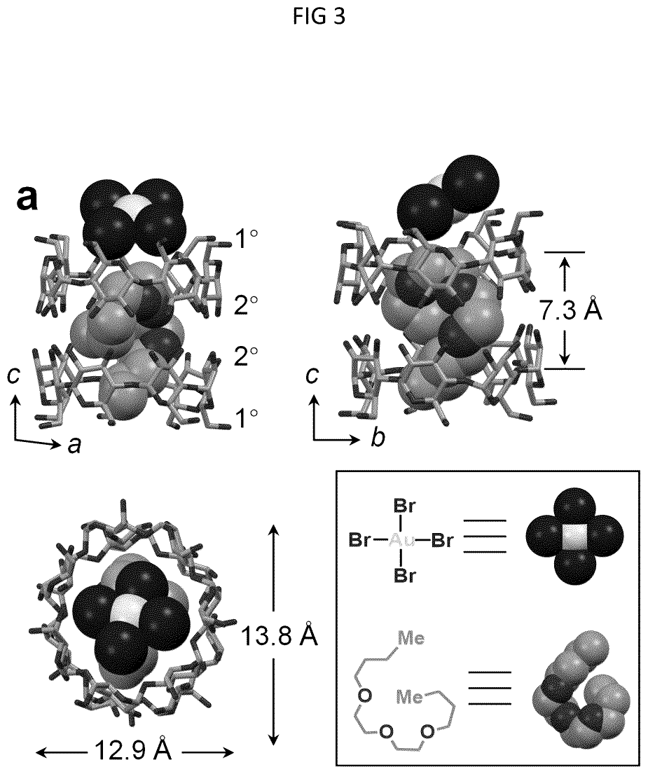

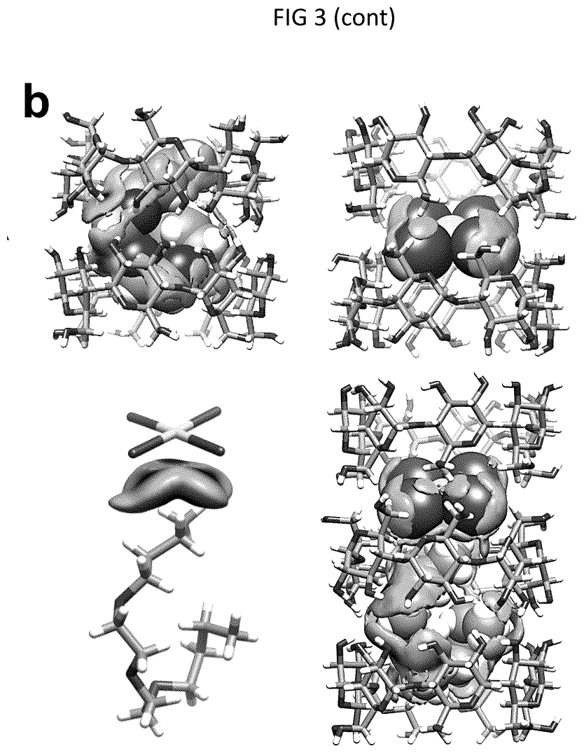

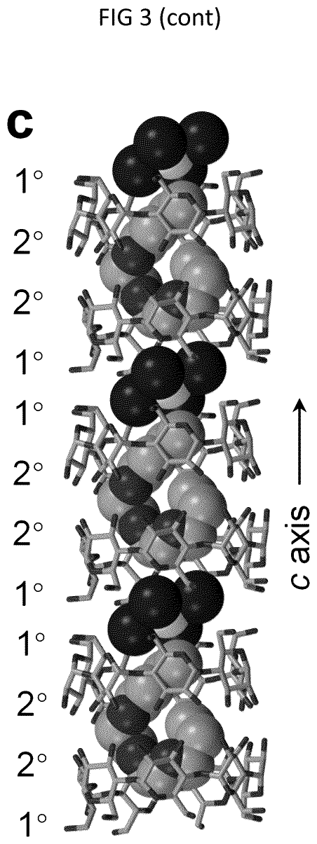

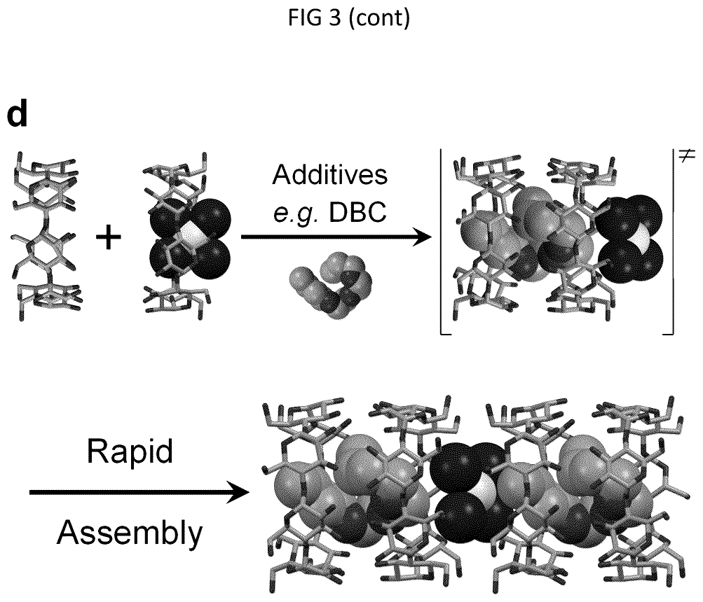

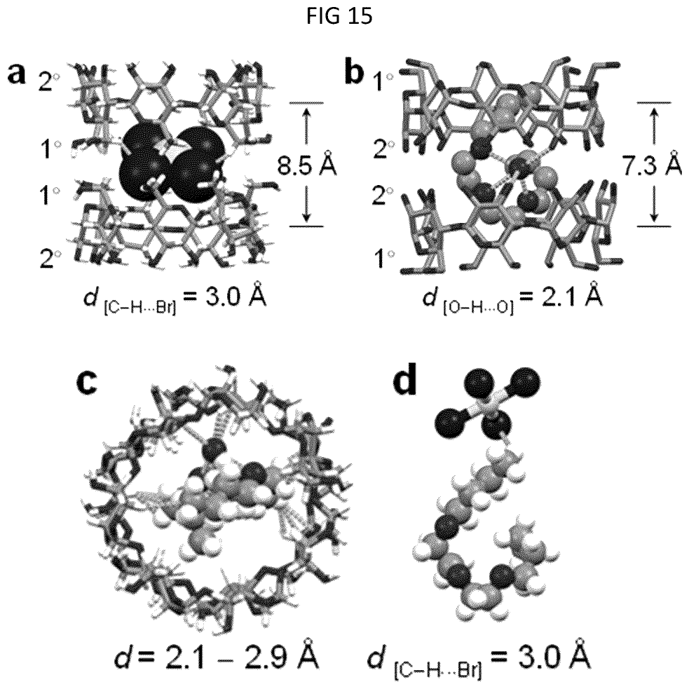

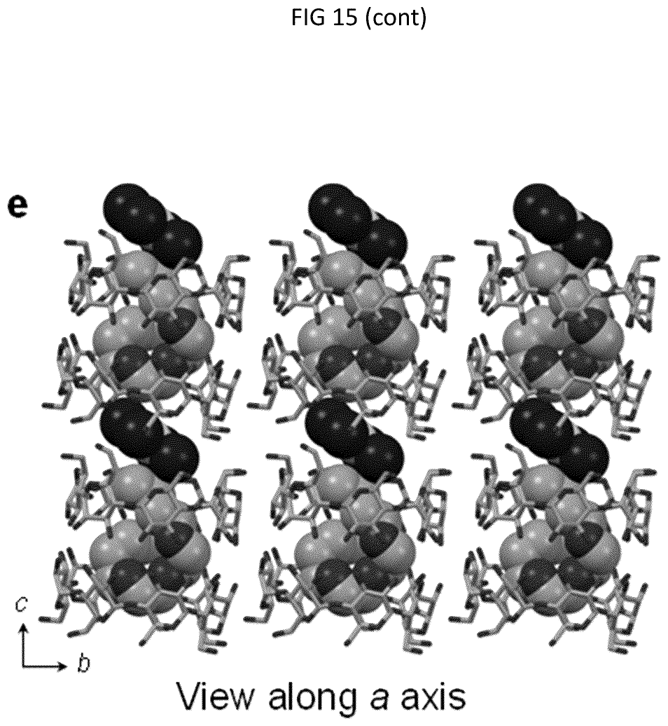

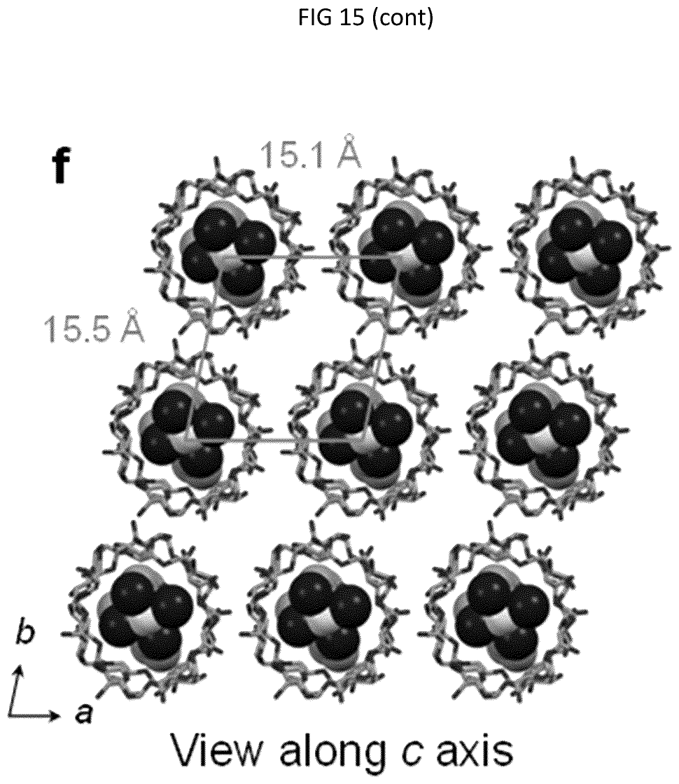

The mechanism for the DBC-induced supramolecular polymerization has been elucidated by X-ray crystallography. Brown single crystals of the ternary complex formed between KAuBr₄, β-CD, and DBC were obtained by slow vapor diffusion of DBC into an aqueous solution of KAuBr₄ and β-CD over 3 days. Single-crystal X-ray diffraction analysis reveals that the [AuBr₄]⁻ anion is centered (FIG. 3a) between the primary faces of two adjacent β-CD tori. The H-5 protons on the primary faces of the two neighboring β-CD tori are close (FIG. 3b) to the four bromine atoms in the [AuBr₄]⁻ anion with [C—H···Br-Au] contacts ranging from 3.2 to 3.5 Å (Table 2). All the H-6 protons on the two β-CD tori are in close contact with bromine atoms. The [C—H···Br-Au] distances range from 3.0 to 3.3 Å (Table 2). The multiple [C—H···Br-Au] hydrogen bonding interactions between the inward-facing H-5 and H-6 protons and the four bromine atoms constitute the major interactions anchoring the [AuBr₄]⁻ anions. Additionally, the bromine atoms in the [AuBr₄]⁻ interact (FIG. 3b) with DBC on account of a [C—H···Br-Au] hydrogen bond with a distance (FIG. 15d) of 3.0 Å, while DBC occupies (FIG. 3a) the internal cavities of two neighboring β-CD tori. With the DBC serving as a connector and multiple intermolecular hydrogen bonds between the secondary faces, the two β-CD tori adopt (FIG. 3b) a head-to-head packing arrangement, forming a supramolecular dimer. Because the length (18.7 Å) of stretched out DBC is much longer than the depth (13.2 Å) of the β-CD dimer, DBC adopts (FIG. 3a) a folded conformation inside the internal cavity of the dimer in order to maximize surface contacts. The folded DBC is sustained (FIG. 15c) by two sets of [H—O···H—C] hydrogen bonds between the oxygen atoms on the secondary faces of the β-CD tori and the methylene hydrogens on DBC, as well as multiple Van der Waals interactions between inward-facing H-3 and H-5 protons on the β-CD tori and the carbon and hydrogen atoms in DBC. The two [H—O···H—C] distances were found (FIG. 15c) to be 2.6 and 2.7 Å, while the distances associated with the Van der Waals interactions range (FIG. 15c) from 2.1 to 2.9 Å. The β-CD tori undergo (FIG. 3a) elliptical deformations to accommodate the folded conformations of DBC, where the lengths of the major and minor axes for the distorted β-CD tori are 13.8 and 12.9 Å, respectively. It is worth mentioning that K⁺ ions are absent (FIG. 15) in the crystal superstructures. A possible explanation is that protons replace K⁺ ions during crystallization. With the [AuBr₄]⁻ anions and DBC molecules as connectors, the β-CD tori are arranged (FIG. 3c) in a head-to-head and tail-to-tail manner extending along the c axis, forming an infinite one-dimensional (1D) supramolecular polymer. Bundles of these polymers are tightly packed as a result of intermolecular hydrogen bonds between the ID columns, forming needle-like single crystals. The simulated PXRD pattern, derived from the single-crystal X-ray crystallographic data of HAuBr₄·DBC⊂2β-CD, matches (FIG. 2e) well with the experimental one, indicating that the superstructure of the HAuBr₄·DBC⊂2β-CD microcrystals obtained by solution-phase synthesis is consistent with its single-crystal X-ray diffraction analysis.

Based on the solid-state superstructures of [AuBr₄]⁻ and β-CD, obtained before and after adding DBC, we propose the mechanism (FIG. 3d) of additive-induced rapid cocrystallization and concomitant co-precipitation. In the aqueous solution of [AuBr₄]⁻ and β-CD, the primary species are the 1:1 [AuBr₄]⁻⊂β-CD complex and free β-CD. After adding the hydrophobic DBC, it serves as a secondary guest by co-occupying the binding cavity of two β-CD tori and forces the [AuBr₄]⁻ anions to move to the primary faces of the β-CD tori, forming a unique heterodimeric encapsulation complex. With DBC connecting the two secondary faces and [AuBr₄]⁻ anions linking two primary faces of the β-CD tori, the complexes assemble spontaneously into stable 1D supramolecular nanostructures. The ordered accumulation of these supramolecular nanostructures forms large needle-like nanocrystals.

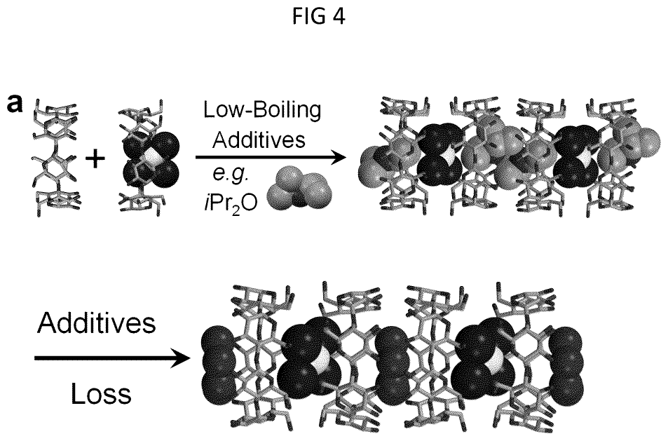

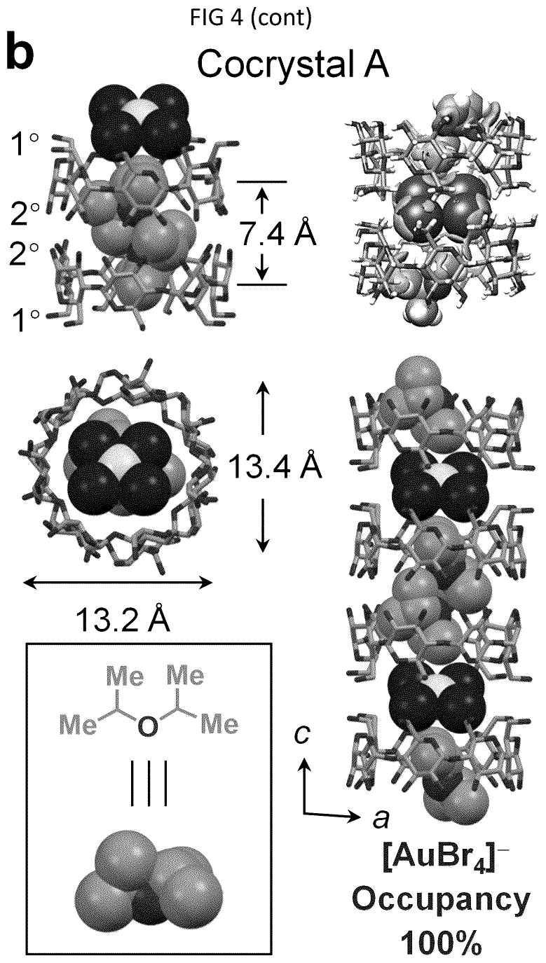

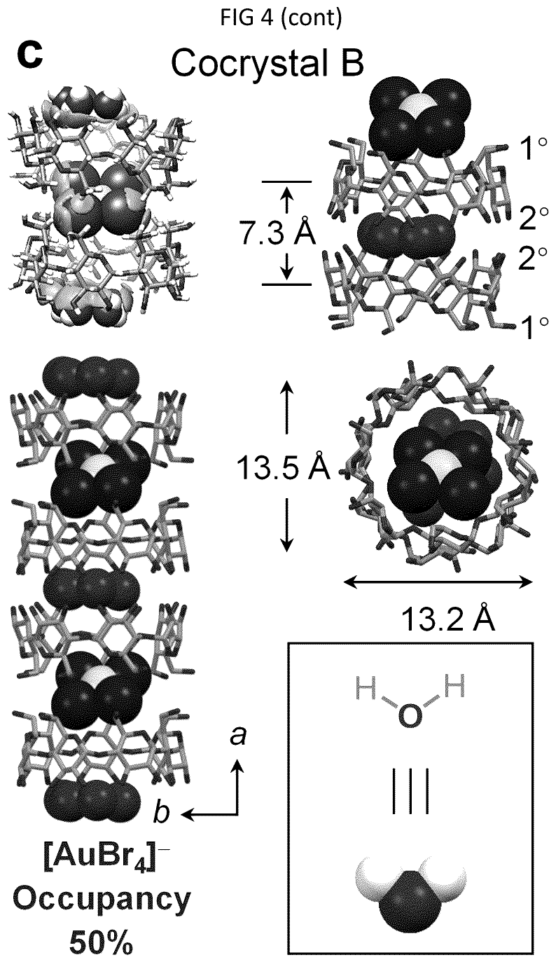

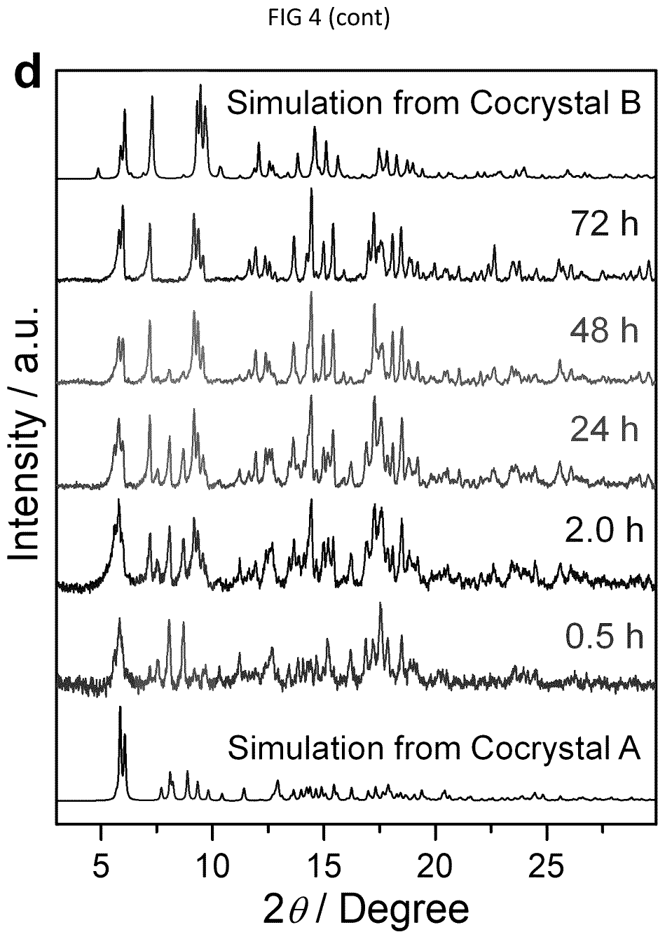

Brown cocrystals of the HAuBr₄·2(iPr₂O)⊂2β-CD adduct were also obtained after layering iPr₂O on top of an aqueous solution of the [AuBr₄]⁻⊂β-CD complex for 12 h. X-Ray crystallography reveals that the HAuBr₄·2(iPr₂O)⊂2β-CD complex adopts (Table 5) the same triclinic space group P1 as that of the HAuBr₄·DBC⊂2β-CD complex. In its solid-state superstructure, the [AuBr₄]⁻ anions are located (FIG. 4b) between the primary faces of two β-CD tori, sustained by the multiple [C—H···Br-Au] interactions, an observation which is similar to that in the crystal superstructure of the HAuBr₄·DBC⊂2β-CD complex. The DFT-calculated binding energy between β-CD and [AuBr₄]⁻ in the HAuBr₄·2(iPr₂O)=2β-CD cocrystal, however, is lower than that in the HAuBr₄·DBC⊂2β-CD cocrystal. Two iPr₂O molecules are positioned (FIG. 4b) in the cavities and secondary faces of a β-CD dimer on account of intermolecular [C—H···O] hydrogen bonds and the hydrophobic effect. The binding energy between β-CD and iPr₂O is much lower than that between β-CD and DBC. With the [AuBr₄]⁻ anions and iPr₂O located alternately at their primary and secondary faces, the β-CD tori are arranged repeatedly in the order head-to-head and tail-to-tail along the c axis. Notably, the space groups of the HAuBr₄·2(iPr₂O)⊂2β-CD cocrystals change (Table 5) from triclinic P1 to monoclinic P21 after the cocrystals remain in their mother liquid for 3 days, indicating the crystals undergo (FIG. 4a) a cocrystal-to-cocrystal transformation. For convenience, the initial and transformed cocrystals are described as cocrystal A (FIG. 4b) and cocrystal B (FIG. 4c). In the solid-state superstructure of cocrystal B, only the [AuBr₄]⁻ anions and β-CD were observed (FIG. 4c), whereas iPr₂O was absent. The [AuBr₄]⁻ anions are located (FIG. 4c) in the interspace between the primary faces of two β-CD tori, while the lattice space between the secondary faces of the two β-CD tori is occupied (FIG. 4c) by disordered H₂O molecules. The disordered H₂O molecules take over (FIG. 4a) the role of iPr₂O, holding the two secondary faces of the β-CD tori together. The loss of iPr₂O may be the reason for triggering the cocrystal transformation. Notably, the occupancy for the [AuBr₄]⁻ anions is (FIG. 4c) 50% in cocrystal B, while the [AuBr₄]⁻ anions achieve (FIG. 4b) full occupancy in cocrystal A, demonstrating half of the [AuBr₄]⁻ anions escape into solution during cocrystal transformation. The reason may be because of the lower binding energy between the central [AuBr₄]⁻ anions and their surrounding species in cocrystal B compared with cocrystal A.

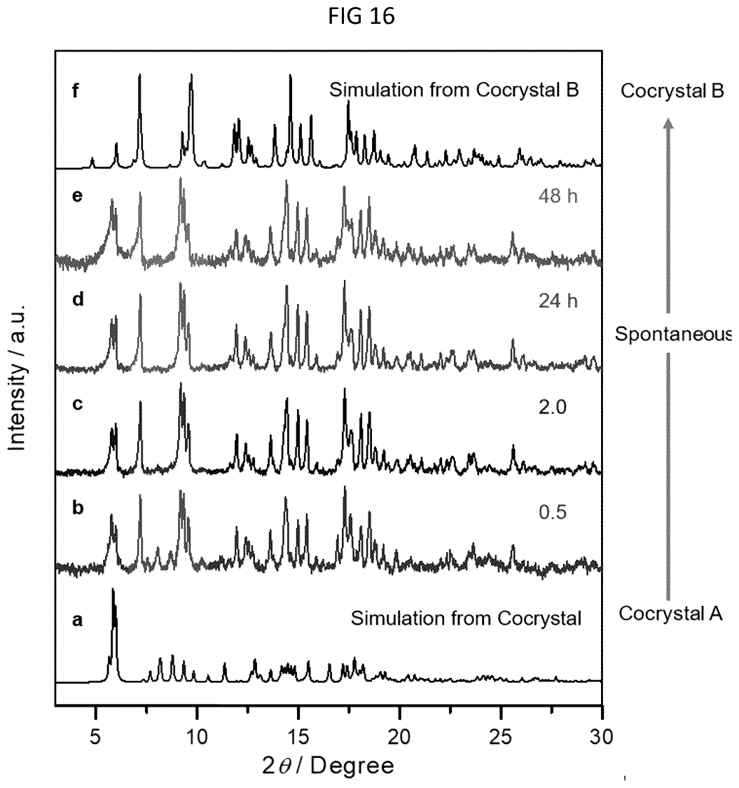

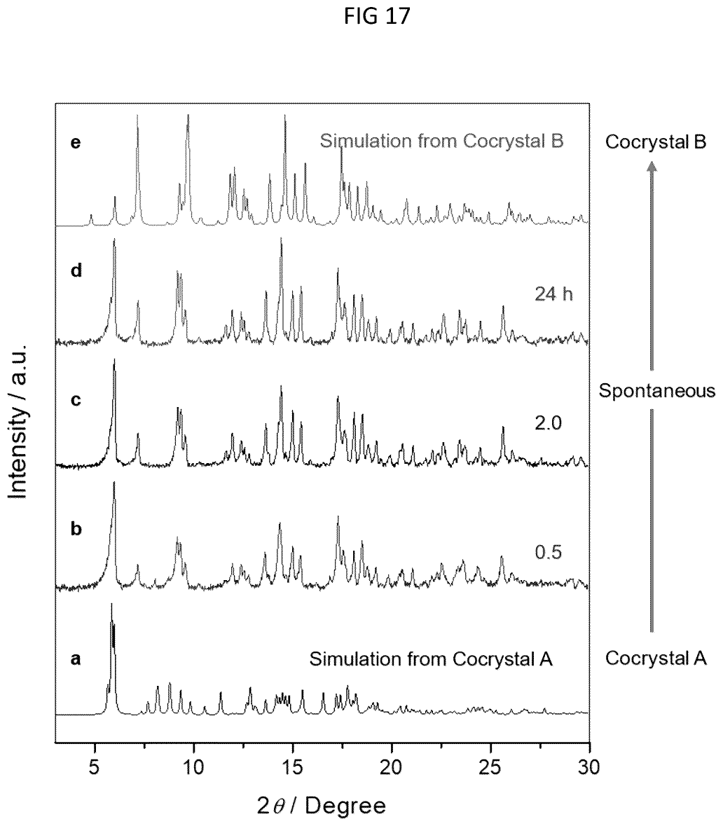

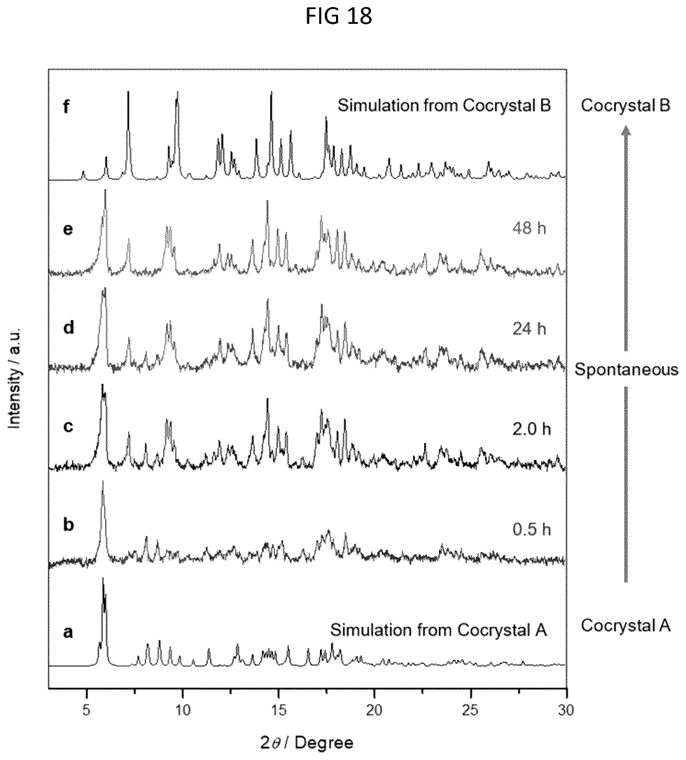

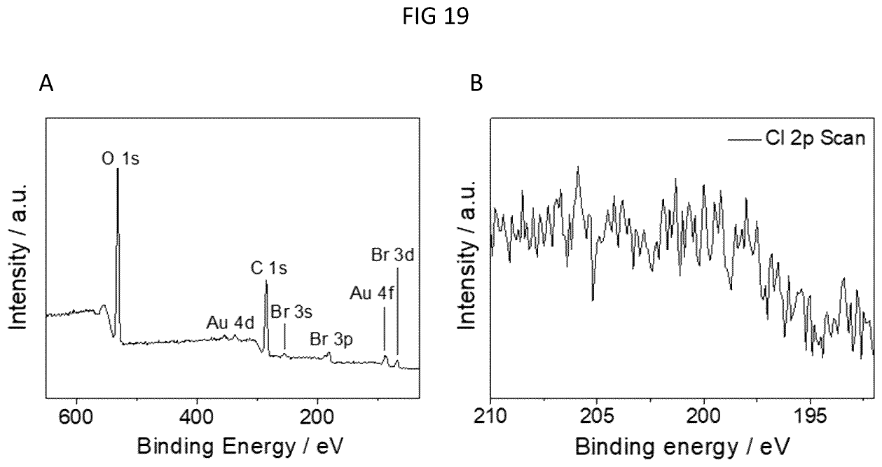

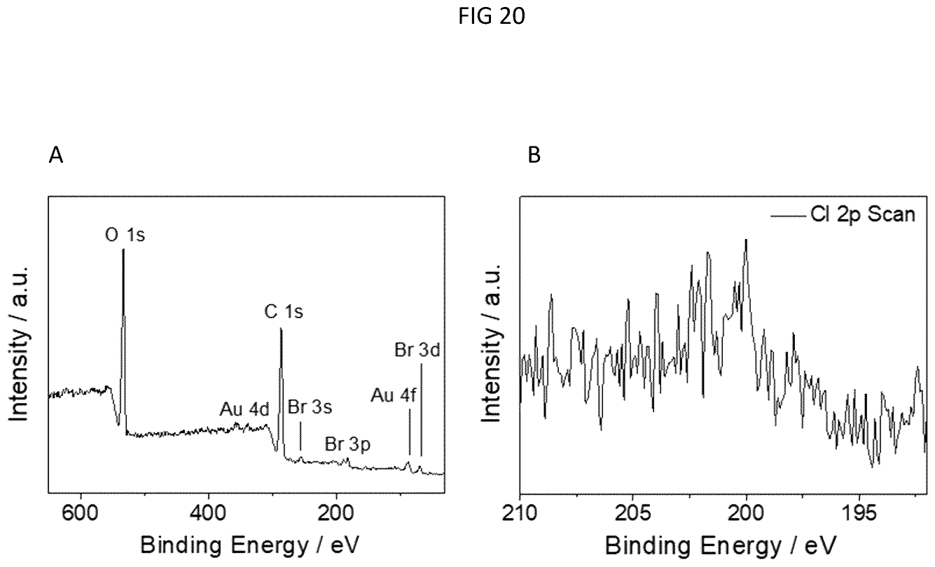

The PXRD confirms the cocrystal-to-cocrystal transformation. The PXRD patterns of the co-precipitates, obtained by adding iPr₂O to the mixture of β-CD and [AuBr₄]⁻ anions, change (FIG. 4d) over time. The HAuBr₄·2(iPr₂O)⊂2β-CD suspension, which settles at the bottom of vials after standing 0.5 h, was subjected to powder XRD analysis. Its PXRD pattern is consistent (FIG. 4d) with the simulated pattern based on the single-crystal X-ray data for HAuBr₄·2(iPr₂O)⊂2β-CD (Cocrystal A), indicating that the co-precipitate possesses the same superstructure as cocrystal A. When the HAuBr₄·2(iPr₂O)⊂2β-CD suspension was allowed to stand at room temperature for 2.0, 24, and 48 h, the intensity of the feature peaks at 8.1° and 8.7° for cocrystal A became (FIG. 4d) lower and lower, while a set of new peaks appeared gradually at 7.2° and 9.4°. The PXRD pattern of the co-precipitates remained unchanged after standing for 2 days. The final pattern is analogous (FIG. 4d) to the simulation derived from the single-crystal X-ray crystallographic data for cocrystal B. These observations demonstrate that co-precipitates transform (FIG. 4a) spontaneously from cocrystal A to cocrystal B within 2 days. Combined with the solid-state superstructures of cocrystals A and B, we conclude that (i) iPr₂O molecules, bound inside the cavity of β-CD, have been replaced by disordered H₂O molecules during the cocrystal-to-cocrystal transformation, (ii) ˜50% of [AuBr₄]⁻ anions escape from the co-precipitates into aqueous solutions during the transformation. These observations may be the reason for the yield of gold-bearing co-precipitate obtained upon adding iPr₂O being lower (FIG. 2b) than that upon adding DBC. According to PXRD patterns, the co-precipitates obtained on adding other low-boiling solvents, e.g., hexane, CH₂Cl₂ and CHCl₃, also undergo (FIGS. 16-18) the cocrystal-to-cocrystal transformation over time, while the co-precipitates obtained on adding high-boiling solvents, e.g., DBC, benzene and toluene, exhibit no obvious changes over time. In the X-ray photoelectron spectra of the co-precipitates obtained by adding CH₂Cl₂ (FIG. 19) and CHCl₃ (FIG. 20), the signal for chlorine is absent, confirming the loss of CH₂Cl₂ and CHCl₃ during the cocrystal transformation. Additionally, the yields of gold-bearing co-precipitates, after adding high-boiling solvents, are much higher (FIG. 2b) than those upon adding low-boiling solvents, suggesting that the cocrystal-to-cocrystal transformation is unfavorable to gold recovery.

We believe that several factors need to be considered when choosing suitable additives to recover gold based on our results. They include-(i) Additives should be hydrophobic and possess a relatively high binding affinity for β-CD, which allows them to participate in the co-assembly process. (ii) Additives should be size-matched with the cavity of β-CD and able to share the cavity together with the [AuBr₄]⁻ anion, which allows for the formation of ID supramolecular nanostructures. (iii) Additives with high boiling points are preferred when it comes to improving the stability of the cocrystals. (iv) Additives should be cheap and readily available, so as to reduce costs. (v) Additives should be eco-friendly, an attribute which is vital to sustainable development and environmental protection.

Gold Recovery from Gold-Bearing Scrap

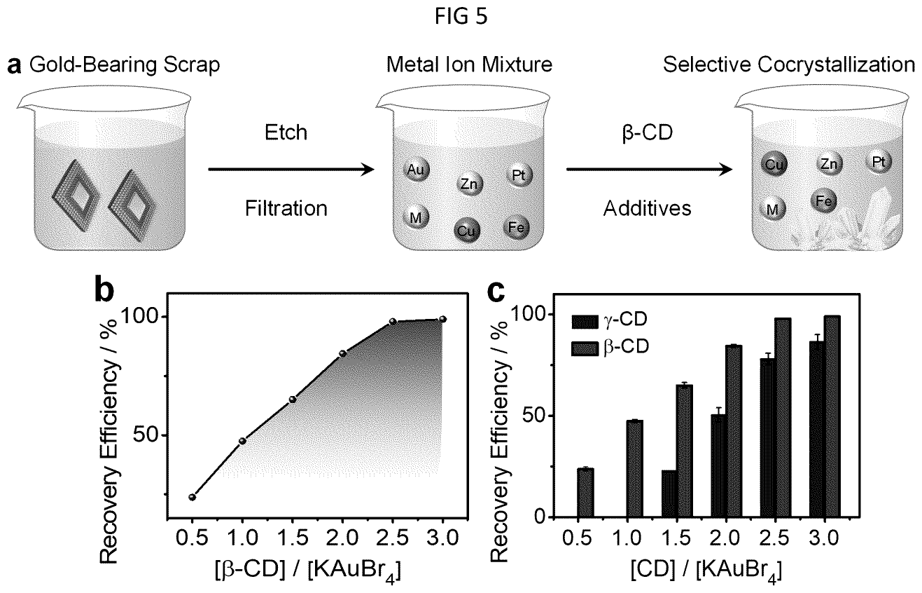

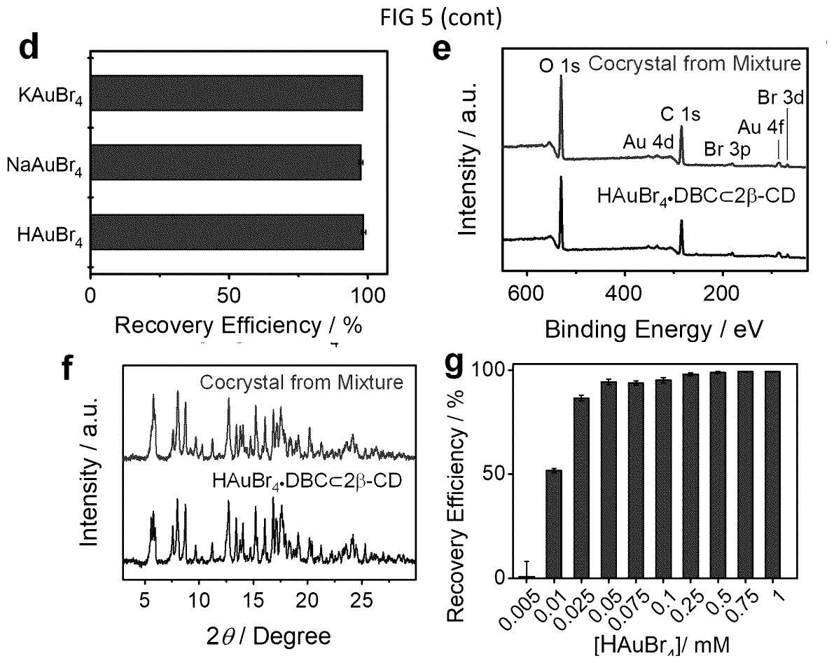

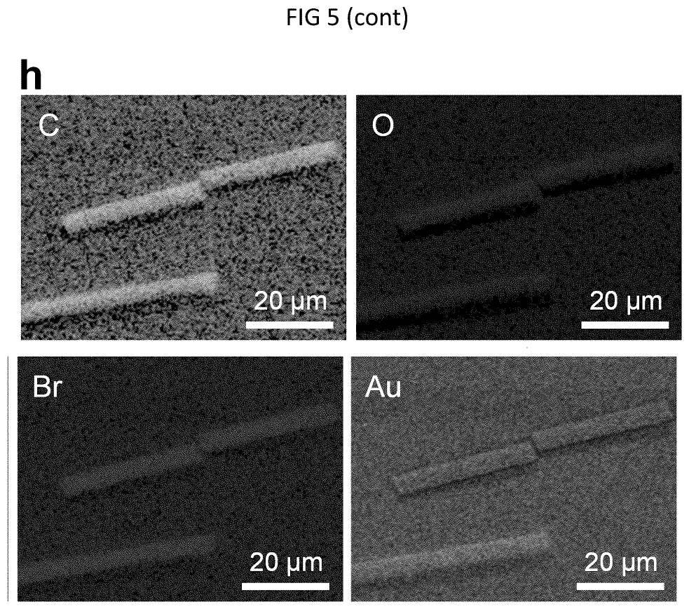

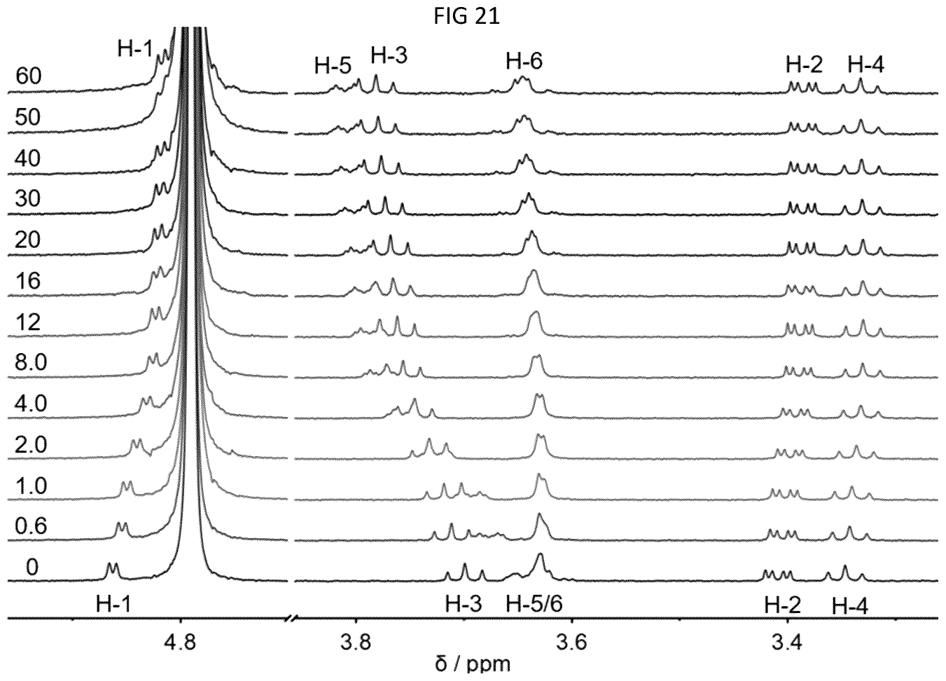

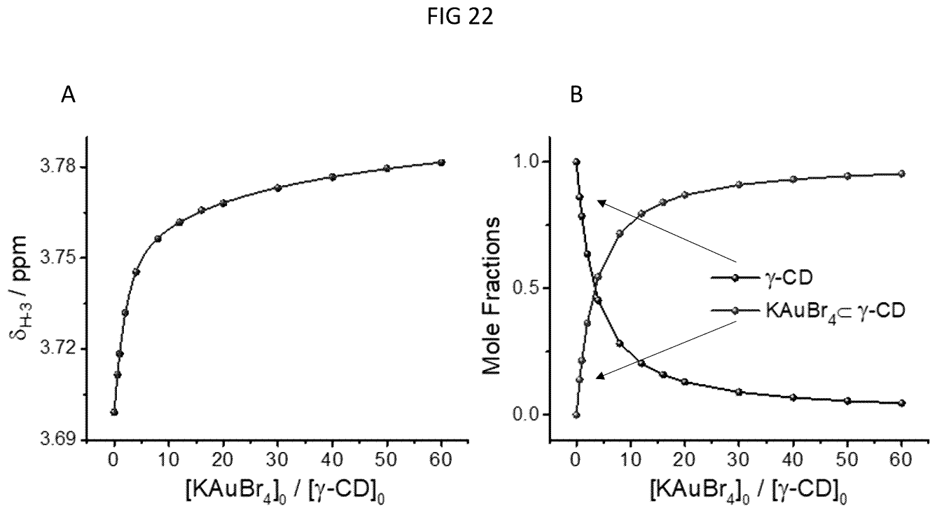

In order to develop a feasible gold-recovery protocol based on additive-induced supramolecular polymerization, the influence of CD and gold salts on gold-recovery efficiency was also investigated. The β-CD-to-KAuBr₄ ratio was optimized first of all. Six samples with different molar ratios of β-CD-to-KAuBr₄ from 0.5 to 3 were prepared. After adding 0.1% (v/v) of DBC, all six clear solutions turned cloudy. The UV-Vis absorption spectra reveal (FIG. 5b) that the gold-recovery efficiencies, based on co-precipitates, increase gradually from 23.8 to 99.0% upon changing the molar ratio of β-CD-to-KAuBr₄ from 0.5 to 3.0. Notably, the gold-recovery efficiency reaches a plateau when the molar ratios rise to (FIG. 5b) 2.5, suggesting that two β-CD tori are required to complex with each [AuBr₄]⁻ anion. γ-CD with a larger binding cavity and a lower binding affinity (1.39×10³ M⁻¹, FIGS. 21-22) for [AuBr₄]⁻ anion was also investigated. The gold-recovery efficiencies based on γ-CD are much lower (FIG. 5c) than those obtained when using β-CD at the same CD-to-KAuBr₄ molar ratio, indicating that β-CD is a better candidate for gold recovery than γ-CD.

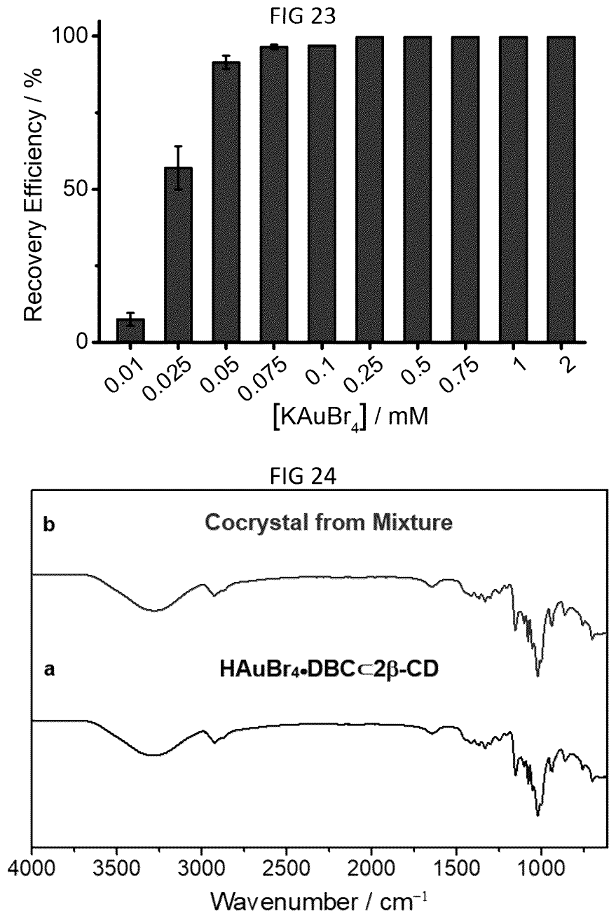

The effect of the countercation of the gold salts on gold-recovery efficiency has also been investigated. After adding 0.1% (v/v) of DBC to the two aqueous solutions containing NaAuBr₄⊂β-CD and HAuBr₄CB-CD complexes, a large amount of brown co-precipitates was formed in both solutions. The corresponding gold-recovery efficiencies (FIG. 5d) are 97.5% (NaAuBr₄) and 98.5% (HAuBr₄), values which are almost identical to that (98.0%) for KAuBr₄. This observation suggests that the additive-induced supramolecular polymerization is independent of the cation associated with the gold salts. Considering that the direct recovery of gold from the leaching solution at low concentration could be a challenge to the industry, we investigated the effect of the concentration of [AuBr₄]⁻ anions on gold-recovery efficiency. UV-Vis Absorption spectra reveal (FIG. 23) that over 91.5% of gold in the solutions can be precipitated when the concentration of KAuBr₄ is ≥0.05 mM (9.3 ppm). This observation shows that the technology can be used to recover gold from leaching solutions at low concentrations. Compared with α-CD-based gold-recovery technology⁵⁴, which requires high concentrations of KAuBr₄ (>6 mM), the working concentration of [AuBr₄]⁻ anions in the current β-CD-based gold-recovery technology is reduced by a factor of 120.

The high performance of additive-induced cocrystallization between β-CD and [AuBr₄]⁻ motivated us to test the practicability of recovering gold from electronic scrap. A spent gold-bearing alloy cable was employed as a sample for developing a laboratory-scale gold-recovery protocol. The cable was etched (FIG. 5a) using a mixture solution of HBr and H₂O₂ to convert Au into HAuBr₄.⁵⁶ The acid concentration of the HAuBr₄-containing solution was adjusted to 1 M. Insoluble impurities were removed by filtration. After adding an aqueous solution of β-CD and 0.1% (v/v) of DBC to the gold-bearing filtrate, yellow microcrystals formed (FIG. 5a) immediately.

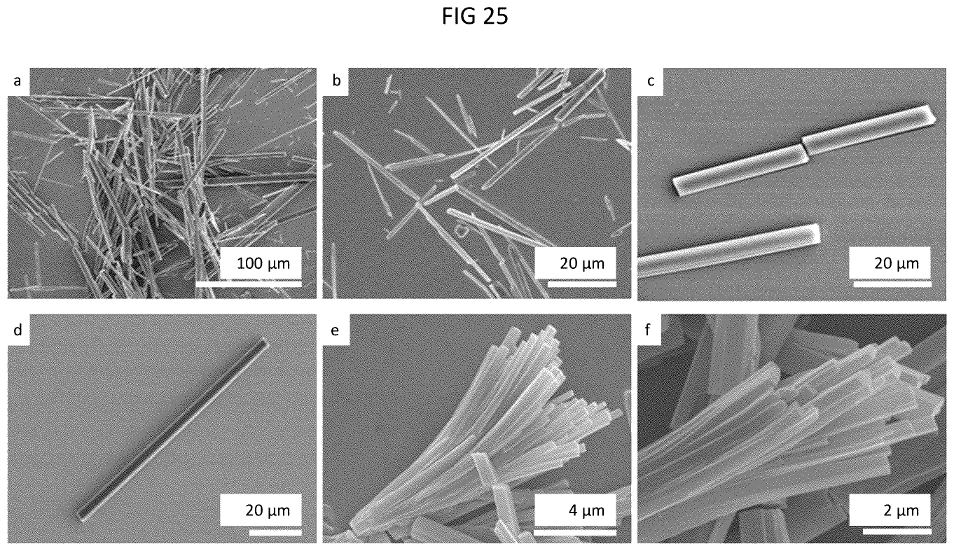

In the X-ray photoelectron spectrum of the microcrystals, only the characteristic peaks of carbon, oxygen, bromine and gold were observed (FIG. 5e), while signals for other metals were absent. The FTIR spectrum of the microcrystals matches (FIG. 24) well with that of the HAuBr₄·DBC⊂2β-CD cocrystal, indicating they have similar components. The similar PXRD patterns (FIG. 5f) between the microcrystals and the HAuBr₄·DBC⊂2β-CD cocrystal demonstrate that the microcrystals obtained from the mixture possess the same solid-state superstructure as the HAuBr₄·DBC⊂2β-CD cocrystal. These observations indicate that the additive-induced supramolecular polymerization between HAuBr₄, DBC and β-CD is highly selective, and that the presence of large amounts of other metals has a negligible impact on the additive-induced crystallization process. SEM Analysis uncovers that the microstructure of the yellow microcrystals is similar to that of the HAuBr₄·DBC⊂2β-CD adduct. Many microrods were observed (FIG. 25) in the SEM images. SEM-EDS Revealed (FIG. 5h) that all the elements, including carbon, oxygen, bromine and gold, were distributed uniformly in the microrods. The microscopic investigation and elemental analysis confirmed the high specificity of the cocrystallization. The ICP-MS analysis (FIG. 5g) indicated 99.0% of the [AuBr₄]⁻ anions are separated from the leaching solution at a concentration of 0.5 mM (93 ppm), a value which is close to the precipitation efficiency (99.8%) obtained when adding 0.1% (v/v) of DBC to a solution of the KAuBr₄⊂β-CD complex. In order to demonstrate the applicability of the additive-induced supramolecular polymerization to recover a smaller amount of gold, two mixtures containing 9.3 and 4.7 ppm of gold were prepared. ICP-MS analysis indicates (FIG. 5g) that 94.4 and 86.6% of gold in them were precipitated. These results suggest that the additive-induced polymerization can be used to recover the gold from low-grade gold ores and low-concentration gold-bearing electronic scrap. Finally, the gold metal was recovered from the yellow co-precipitate after reduction with N₂H₄·H₂O. The β-CD can be recycled by precipitating with acetone and followed by recrystallization. Based on this laboratory-scale gold-recovery experiment, a gold-recovery flow diagram (FIG. 26) has been proposed.

### DISCUSSION

An eco-friendly and sustainable supramolecular metallurgical technology for gold recovery has been demonstrated. It is based on an additive-induced supramolecular polymerization of second-sphere coordinated adducts formed between β-cyclodextrin and tetrabromoaurate anions. The additives drive the assembly by obliging the tetrabromoaurate anions to move from the inner cavity to the primary face of two β-cyclodextrin tori, while themselves occupying the space between the secondary faces of two β-cyclodextrin tori, leading to the formation of infinite 1D supramolecular nanostructures that precipitate from the aqueous solutions as cocrystals. This additive-induced supramolecular polymerization, not only provides a feasible method for the rapid crystallization of the supramolecular polymers, but it also opens the door for regulating the assembly behavior of second-sphere coordinated adducts.

In contrast to the traditional antisolvent precipitation method, the additive-induced polymerization reported in this research provides the following advantages-(i) It only requires a small volume fraction (<0.3%) of additives to effectively precipitate the target compound with a high recovery efficiency (>99.5%). (ii) The additives do not have to be mixable with the solution. (iii) The molecular recognition driven supramolecular polymerization is highly selective for the precipitation of target compounds in the presence of other structurally similar substrates.

From a practical viewpoint, this research describes a highly efficient and sustainable gold-recovery protocol. Compared with our previously reported⁵⁴ protocol using α-cyclodextrin, the additive-induced polymerization with β-cyclodextrin comes with the following attributes (i) The gold-recovery can be performed at a low concentration (9.3 ppm) with a much better recovery efficiency (>94%). (ii) No additional potassium ions are needed. (iii) Co-precipitation can be performed directly in acidic leaching solutions without the need of neutralization. (iv) The cost of β-cyclodextrin is lower than that of α-cyclodextrin. In summary, our establishment of additive-induced polymerization constitutes an attractive strategy for the practical recovery of gold and leads to significantly reduced energy consumption, cost inputs, and environmental pollution. We are currently optimizing the strategy to recover gold from lower-concentration gold-bearing e-waste and exploring the generality of this strategy to separate other target metal ions.

### Methods

Materials. The compounds HAuBr₄, NaAuBr₄, KAuBr₄, K₂PdBr₄, K₂PtBr₄, β-CD, γ-CD, DBr (wt 47-49%) in D₂O, HBr (wt 47-49%) and H₂O₂ (wt 30%) were purchased from commercial suppliers and used without further purification. All the additives, i.e., dibutyl carbitol (DBC), isopropyl ether (iPr₂O), diethyl ether (Et₂O), hexane, ethyl acetate, dichloromethane (CH₂Cl₂), chloroform (CHCl₃), benzene, toluene, olive oil, vegetable oil and pump oil are commercially available. Ultra pure water was generated by a Milli-Q system.

UV-Vis Absorption spectroscopy. UV-Vis Absorption spectra were recorded in 1 M HBr aqueous solutions at 298 K. UV-Vis Absorption spectra were recorded on a UV-3600 Shimadzu spectrophotometer in rectangular quartz cells with light paths of 4 mm. Each gold-recovery experiment was duplicated independently, and the average gold-recovery efficiencies are presented with their standard deviations.

Fourier-transform infrared spectroscopy. Fourier-transform infrared (FT-IR) spectroscopy was performed on a Nexus 870 spectrometer (Thermo Nicolet) in the mode of attenuated total reflection (ATR) with the range from 4000 to 600 cm⁻¹ and at a resolution of 0.125 cm⁻¹.

NMR Spectroscopy. NMR Spectra were recorded on a Bruker Avance III 600 MHZ spectrometer in D₂O containing 0.5 M DBr. Chemicals shifts (8) are given in ppm with residual H₂O signals as a reference. ¹H NMR Titrations: Highly-concentrated solutions of KAuBr₄, K₂PdBr₄, or K₂PtBr₄ in D₂O (containing 0.5 M DBr) as the titrating solution was added dropwise to a D₂O solution (containing 0.5 M DBr) of β-CD or β-CD. Binding constants were obtained by fitting a 1:1 isotherm according to the programs available at http://app.supramolecular.org/bindfit/. Crystallization and single-crystal X-ray diffraction analyses. The KAuBr₄⊂β-CD complex: Brown single crystals were obtained by slowly cooling an aqueous solution of KAuBr₄ and β-CD from 90° C. to room temperature over 6 h. The HAuBr₄DBC⊂2β-CD complex: Brown single crystals were obtained by slow vapor diffusion of DBC into an aqueous solution of KAuBr₄ containing 2 molar equivalents of β-CD over 3 days. The HAuBr₄·2(iPr₂O)⊂2β-CD complex (Cocrystal A): Brown single crystals were obtained by slow liquid-liquid diffusion of iPr₂O into an aqueous solution containing KAuBr₄ and 2 molar equivalents of β-CD over 12 h. The 0.5(HAuBr₄)=2β-CD complex (Cocrystal B): Brown single crystals were obtained by allowing the HAuBr₄·2(iPr₂O)=2β-CD suspension to stand at room temperature for 3 days. The suitable crystals were mounted on a MITIGEN holder in Paratone oil on a Rigaku XtaLAB Synergy, Single source at home/near, HyPix diffractometer using CuKα (λ=1.5418 Å) or MoKα (λ=0.7107 Å) radiation. Data were collected using the Bruker APEX-II or Rigaku CrysAlis Pro program. The superstructures were solved with the ShelXT program using intrinsic phasing and refined with the ShelXL refinement package using least squares minimization in OLEX2 software.

Powder X-ray diffraction analysis. Powder X-ray diffraction (PXRD) analyses were performed on an STOE-STADI MP powder diffractometer equipped with an asymmetrically curved Germanium monochromator (Cu-Kα1 radiation, λ=1.54056 Å) and a one-dimension silicon strip detector (MYTHEN2 1K from DECTRIS). Samples for superstructural analysis were measured at room temperature in transmission mode. The simulated PXRD patterns were calculated using the Mercury software 4.3.0.

X-Ray photoelectron spectroscopy. X-Ray photoelectron spectroscopic (XPS) analyses were conducted on a fully digital state-of-the-art X-ray photoelectron spectrometer (Thermo Scientific ESCALAB 250Xi), which was equipped with an electron flood gun and a scanning ion gun. The diameter of the X-ray spot was 500 μm, and the scan range was from 0 to 1200 eV.

Inductively coupled plasma mass spectrometry. ICP-MS was performed on a computer-controlled (QTEGRA software) Thermo iCapQ ICP-MS (Thermo Fisher Scientific, Waltham, MA, USA) operating in STD mode and equipped with an ESI SC-2DX PrepFAST autosampler (Omaha, NE, USA). The internal standard was added inline using the prepFAST system and consisted of 1 ng/ml of a mixed element solution containing Bi, In, ⁶Li, Sc, Tb, Y (IV-ICPMS-71D from Inorganic Ventures). Online dilution was also carried out by the prepFAST system and used to generate a calibration curve consisting of 100, 50, 20, 10, 5 and 1 ppb Au. Each sample was acquired using one survey run (10 sweeps) and three main (peak jumping) runs (40 sweeps). The isotopes selected for analysis were ¹⁹⁷Au and ⁸⁹Y, ¹¹⁵In, ¹⁵⁹Tb, and ²⁰⁹Bi (chosen as internal standards for data interpolation and machine stability). Instrument performance was optimized daily by auto-tuning, followed by verification with the aid of a performance report.

Scanning electron microscopy. Scanning electron microscopic (SEM) images were obtained on a SU8030 scanning electron microscope at the voltages of 10/15 kV, while the energy-dispersive X-ray spectroscopy (EDS) elemental maps were recorded at 15 kV.

Density functional theory calculations. The superstructures from the single-crystal X-ray diffraction were used for the density functional theory (DFT) calculations in the Orca program (version 4.1.2) using the hybrid generalized gradient approximation (GGA) Becke three-parameter Lec-Yang-Parr (B3LYP) functional, the Ahlrich's double zeta basis set with a polarization function Def2-SVP, and Grimme's third generation atom-pairwise dispersion correction with Becke Johnson damping (D₃BJ); an integration grid of four was used throughout. To further speed up the DFT optimizations, the Coulomb integral and numerical chain-of-sphere integration for the HF exchange (RIJCOSX) method was applied with the Def2/J auxiliary basis.

Additive-induced ternary cocrystallization experiments. Aqueous stock solutions of KAuBr₄ were prepared by dissolving directly the corresponding commercially available salt in an aqueous HBr (2 M) solution, while an aqueous solution of β-CD was prepared by dissolving the β-CD powder in ultra purity water. The addition of 2 molar equivalents of β-CD (1 mL, 10 mM) to a KAuBr₄ (1 mL, 5 mM) aqueous solution led to the formation of a 1:1 KAuBr₄⊂β-CD complex. When specific additives (0.1% v/v) were added to the resulting aqueous solutions, yellow suspensions were formed immediately. The yellow solids were isolated by filtration, washed, and air-dried. The concentrations of [AuBr₄]⁻ remaining in the filtrates were determined by UV-Vis absorption spectroscopy or ICP-MS analysis. The metal precipitation yields were calculated based on the aqueous solution's initial and residual concentrations of metal anions.

Gold recovery from scrap. A gold-bearing cable was obtained from the local electronic junk shop. The yellow cable (15 mg) was firstly leached with a mixture of HBr and H₂O₂ overnight. Subsequently, the acid concentration in the HAuBr₄-containing leaching solution was adjusted to 1 M with ultra pure H₂O, and the insoluble impurities were removed by filtration. A saturated aqueous solution of β-CD containing ˜1 M HBr was added to the leaching solution, forming the HAuBr₄CB-CD complex. Upon adding 0.1% (v/v) of DBC, the solution became gradually cloudy. After stirring for 5 mins, the co-precipitate of HAuBr₄·DBC⊂2β-CD was separated from other metals by filtration and washed with ultra pure H₂O. The metals trapped in the co-precipitates were analyzed by ICP-MS by comparing with the metal concentrations of the solution before and after adding DBC. In order to convert the [AuBr₄]⁻ anions tapped in the co-precipitate to gold metal, the HAuBr₄·DBC⊂2β-CD co-precipitates were dispersed in an aqueous solution and reduced with N₂H₄·H₂O. After centrifugation and washing with H₂O to dissolve the residual β-CD, gold metal was obtained. β-CD, which dissolves in the aqueous solution, can be recycled by precipitating with acetone and followed by recrystallization.

### (1) Crystal Superstructure of KAuBr₄⊂β-CD

(a) Method. Brown block-like crystals were obtained by slow cooling of an aqueous solution of KAuBr₄ (100 mM) and β-CD (100 mM) from 90° C. down to room temperature over 6 h. A suitable crystal was selected and mounted on a MITIGEN holder with Paratone oil on an XtaLAB Synergy, Single source at home/near, HyPix diffractometer. The crystals were kept at 100.07 K during the data collection. Using Olex2,⁵⁷ the structure was solved with the ShelXT⁵⁸ structure solution program using Intrinsic Phasing and refined with the XL⁵⁹ refinement package employing Least Squares Minimization. Crystallographic images were produced using Mercury 4.3.0. Distances were measured employing Mercury 4.3.0. The solid-state superstructure of KAuBr₄⊂β-CD is shown in FIG. 1f.
(b) Crystal Parameters. C₄₂H₇₀O₃₅·KAuBr₄·4(H₂O). Mr=1762.75. Brown sheet (0.256×0.197×0.058 mm³). Monoclinic, space group P2₁ (no. 4), a=14.90540(10), b=15.43740(10), c=14.91910(10) Å, α=90.000, β=119.3100(10), γ=90.000°, V=2993.43(4) Å³, Z=2, T=100.07(16) K, μ(CuKα)=9.299 mm⁻¹, Dcalc=1.956 g/mm³, 67088 reflections measured (6.794≤2Θ≤159.682), 12191 unique (Rᵢₙₜ=0.0375, R_{sigma}=0.0273) which were used in all calculations. The final R₁ was 0.0270 (I>2σ(I)) and wR₂ was 0.0711 (all data).
(c) Refinement and solvent treatment details. No special refinement was necessary in the case of solving the solid-state superstructure of KAuBr₄⊂β-CD.

TABLE 1
Intermolecular short distances^{a} (Å) between [AuBr₄]⁻ and the inner
protons H-5 and H-6 in each of the seven glucose subunits of β-CD

| Distances^{a}/Å | Unit 1 | Unit 2 | Unit 3 | Unit 4 | Unit 5 | Unit 6 | Unit 7 |
|---|---|---|---|---|---|---|---|
| Br1/Br2-H6 | 3.8-4.2 | 3.4-4.1 | 3.2-4.9 | 4.1-4.2 | 3.6-3.7 | 3.5-4.4 | 3.4 |
| Br1/Br2-H5 | 3.7 | 4.6-4.8 | 3.6 | 3.3-3.5 | 3.5 | 3.6-4.7 | 3.1 |
| Br3/Br4-H6 | 4.8 | 4.4-4.9 | 4.7 | N^{b} | 4.5 | 4.8-4.9 | 4.6 |
| Br3/Br4-H5 | 3.6 | 4.4-4.5 | 3.3 | 3.3 | 3.4 | 3.3-4.7 | 3.0 |

^{a}Short distance means the distance between two atoms <5 Å.
^{b}N means no interaction between two atoms.

### (2) Crystal Superstructure of HAuBr₄·DBC⊂2β-CD

(a) Method. Two molar equivalents of β-CD (500 μL, 20 mM) were added to an aqueous KAuBr₄ (500 μL, 10 mM) solution containing 1 M HBr. The resulting solution was added to two 1 mL tubes with volumes of 0.20 and 0.45 mL. The tubes were placed in one 20 mL vial containing DBC (100 μL). The vial was sealed with a cap. Slow vapor diffusion of DBC into the mixture of KAuBr₄ and β-CD over the period of 3 days yielded brown single crystals. A suitable crystal was selected and mounted on a MITIGEN holder with Paratone oil on an XtaLAB Synergy, Single source at home/near, HyPix diffractometer. The crystal was kept at 100.15 K during the data collection. Using Olex2,⁵⁷ the structure was solved with the ShelXT⁵⁸ structure solution program using Intrinsic Phasing and refined with the XL⁵⁹ refinement package employing Least Squares Minimization. Crystallographic images were produced using Mercury 4.3.0. Distances were measured employing Mercury 4.3.0. The solid-state superstructure of HAuBr₄·DBC⊂2β-CD is shown in FIG. 3.
(b) Crystal Parameters. 2(C₄₂H₇₀O₃₅)·HAuBr₄·C₁₂H₂₆O₃·14(H₂O). Mr=3258.11. Brown needle (0.1×0.01×0.01 mm³). Triclinic, space group P1 (no. 1), a=15.11370(18), b=15.50618(18), c=15.7047(2) Å, α=88.8635(10), β=81.9417(10), γ=77.0250(10°), V=3550.84(8) Å³, Z=1, T=100.15 K, μ(CuKα)=4.205 mm⁻¹, Dcalc=1.524 g/mm³, 136295 reflections measured (7.422≤2Θ)≤160.428), 27552 unique (Rᵢₙₜ=0.0665, R_{sigma}=0.0394) which were used in all calculations. The final R₁ was 0.0818 (I>2σ(I)) and wR₂ was 0.2238 (all data).
(c) Refinement and solvent treatment details. Enhanced rigid-bond restraint⁶⁰ was applied to partial atoms. The solvent-masking procedure implemented in Olex2 was used to remove the electronic contribution of solvent molecules from the refinement. As the exact solvent content is unknown, only the atoms used in the refinement model and protons that were added for charge balance are reported in the formula here. Total solvent accessible volume/cell=253.6 Å³ [7.1%], Total electron count/cell=91.9.

TABLE 2
Intermolecular short distances^{a} (Å) between
[AuBr₄]⁻ and the inner protons H-5 and H-6 in
each of the seven glucose subunits of the two β-CD tori (A and B)

| Distances^{a}/Å | Unit 1 | Unit 2 | Unit 3 | Unit 4 | Unit 5 | Unit 6 | Unit 7 |
|---|---|---|---|---|---|---|---|
| Br1/Br2-[A]H6 | N^{b} | N^{b} | 3.4-3.7 | 3.3-3.8 | 4.5 | 3.2-3.4 | 3.5-4.3 |
| Br1/Br2-[A]H5 | N^{b} | 4.9 | 3.4 | 3.2 | 4.7-4.9 | 3.5 | 3.5 |
| Br1/Br2-[B]H6 | N^{b} | N^{b} | N^{b} | 3.0-3.8 | 3.3-4.2 | 3.0-3.2 | 4.8 |
| Br3/Br4-[B]H6 | 4.2-4.4 | 3.3-4.9 | 3.2-3.3 | 4.4-4.8 | N^{b} | 4.3-4.6 | 3.3-3.5 |
| Br3/Br4-[B]H5 | 4.1 | 3.5-4.8 | 3.2 | 4.4 | 4.9 | 3.7 | 3.4 |
| Br3/Br4-[A]H6 | 3.3-4.7 | 3.3-3.5 | 4.1 | N^{b} | N^{b} | N^{b} | 3.5-3.6 |

^{a}Short distance means the distance between two atoms <5 Å.
^{b}N means no interaction between two atoms.

(3) Crystal Superstructure of HAuBr₄·2(iPr₂O)⊂2β-CD (Cocrystal A)
(a) Method. Two molar equivalents of β-CD (500 μL, 20 mM) were added to an aqueous KAuBr₄ (500 μL, 10 mM) solution containing 1 M HBr. iPr₂O (20 μL) was layered on top of the mixture of KAuBr₄ and β-CD. High-quality brown crystals were obtained after liquid-liquid diffusion for 12 h. A suitable crystal was selected and mounted on a MITIGEN holder with Paratone oil on an XtaLAB Synergy, Single source at offset/far, HyPix diffractometer. The crystal was kept at 99.9 K during the data collection. Using Olex2,⁵⁷ the structure was solved with the ShelXT⁵⁸ structure solution program using Intrinsic Phasing and refined with the XL⁵⁹ refinement package employing Least Squares Minimization. Crystallographic images were produced using Mercury 4.3.0. Distances were measured employing Mercury 4.3.0. The solid-state superstructure of HAuBr₄·2(iPr₂O)⊂2β-CD is shown in FIG. 4b.
(b) Crystal Parameters. 2(C₄₂H₇₀O₃₅)·HAuBr₄·2(C₆H₁₄O)-8(H₂O). Mr=3136.04. Brown needle (0.1×0.02× 0.01 mm³). Triclinic, space group P1 (no. 1), a=15.1182(8), b=15.3034(9), c=15.5384(8) Å, α=87.704(4), β=81.920(4), γ=76.368(5°), V=3458.9(3) Å³, Z=1, T=99.9(3)K, μ(MoKα)=2.322 mm⁻¹, Dcalc=1.506 g/cm³, 63929 reflections measured (4.082°≤2Θ)≤60.818°, 27941 unique (Rᵢₙₜ=0.2267, R_{sigma}=0.3202) which were used in all calculations. The final R₁ was 0.1437 (I>2σ(I)) and wR₂ was 0.3894 (all data).
(c) Refinement and solvent treatment details. Enhanced rigid-bond restraint⁶⁰ was applied to partial atoms. The solvent-masking procedure implemented in Olex2 was used to remove the electronic contribution of solvent molecules from the refinement. As the exact solvent content is unknown, only the atoms used in the refinement model and protons that were added for charge balance are reported in the formula here. Total solvent accessible volume/cell=393.6 Å³ [11.4%], Total electron count/cell=145.2.

TABLE 3
Intermolecular short distances^{a} (Å) between
[AuBr₄]⁻ and the inner protons H-5 and H-6 in
each of the seven glucose subunits of the two β-CD tori (A and B)

| Distances^{a}/Å | Unit 1 | Unit 2 | Unit 3 | Unit 4 | Unit 5 | Unit 6 | Unit 7 |
|---|---|---|---|---|---|---|---|
| Br1/Br2-[A]H6 | N^{b} | 4.3-4.8 | 3.3-4.0 | 3.4-4.8 | 4.5-4.6 | 3.2-3.4 | 4.0-4.4 |
| Br1/Br2-[A]H5 | N^{b} | 4.4 | 3.3 | 3.6 | 4.4 | 3.7 | 3.6 |
| Br1/Br2-[B]H6 | N^{b} | N^{b} | 4.2 | 3.2-3.4 | 3.1-4.5 | 3.2-3.3 | N^{b} |
| Br3/Br4-[B]H6 | 4.2-4.9 | 3.3-3.7 | 3.3-3.7 | 4.9 | N^{b} | 3.7-4.3 | 3.3-3.5 |
| Br3/Br4-[B]H5 | 4.5-4.8 | 3.2 | 3.4 | 4.8 | 4.9 | 3.5 | 3.2 |
| Br3/Br4-[A]H6 | 3.3-4.3 | 2.9-3.7 | 4.8 | N^{b} | N^{b} | N^{b} | 3.1-3.3 |

^{a}Short distance means the distance between two atoms <5 Å.
^{b}N means no interaction between two atoms.

### (4) Crystal Superstructure of 0.5(HAuBr₄)⊂2β-CD (Cocrystal B)

(a) Method. Two molar equivalents of β-CD (500 μL, 20 mM) were added to an aqueous KAuBr₄ (500 μL, 10 mM) solution containing 1 M HBr in a 3 mL vial without the cap. iPr₂O (20 μL) was layered carefully on top of the mixture of KAuBr₄ and β-CD. High-quality brown crystals were obtained after liquid-liquid diffusion for 3 days. A suitable crystal was selected and mounted on a MITIGEN holder with Paratone oil on an XtaLAB Synergy, Single source at offset/far, HyPix diffractometer. The crystal was kept at 100.0 K during the data collection. Using Olex2,⁵⁷ the structure was solved with the ShelXT⁵⁸ structure solution program using Intrinsic Phasing and refined with the XL⁵⁹ refinement package employing Least Squares Minimization. Crystallographic images were produced using Mercury 4.3.0. Distances were measured employing Mercury 4.3.0. The solid-state superstructure of 0.5(HAuBr₄)⊂2β-CD is shown in FIG. 4c.
(b) Crystal Parameters. 2(C₄₂H₇₀O₃₅)·0.5(HAuBr₄)·23(H₂O). Mr=2943.12. Brown needle (0.05×0.01×0.01 mm³). Monoclinic, space group P2₁ (no. 4), a=15.7110(7), b=24.3931(7), c=18.9812(7) Å, α=90.000, β=108.544(4), γ=90.000°, V=6896.7(5) Å³, Z=2, T=100.0(3) K, μ(Mo Kₐ)=1.228 mm⁻¹, Dcalc=1.417 g/cm³, 168898 reflections measured (4.066°≤2Θ≤50.696°), 25231 unique (Rᵢₙₜ=0.1822, R_{sigma}=0.1014) which were used in all calculations. The final R₁ was 0.1150 (I>26(I)) and wR₂ was 0.3237 (all data).
(c) Refinement and solvent treatment details. Enhanced rigid-bond restraint⁶⁰ was applied to partial atoms. The solvent-masking procedure implemented in Olex2 was used to remove the electronic contribution of solvent molecules from the refinement. As the exact solvent content is unknown, only the atoms used in the refinement model and protons that were added for charge balance are reported in the formula here. Total solvent accessible volume/cell=808.2 Å³ [11.7%], Total electron count/cell=217.1.

TABLE 4
Intermolecular short distances^{a} (Å) between
[AuBr₄]⁻ and the inner protons H-5 and H-6 in
each of the seven glucose subunits of the two B-CD tori (A and B)

| Distances^{a}/Å | Unit 1 | Unit 2 | Unit 3 | Unit 4 | Unit 5 | Unit 6 | Unit 7 |
|---|---|---|---|---|---|---|---|
| Br1/Br2-[A]H6 | N^{b} | 4.9 | 3.1-3.6 | 3.0-3.4 | 3.4-4.5 | 3.5 | 3.4-3.8 |
| Br1/Br2-[A]H5 | 4.8 | 4.9 | 3.2 | 2.9 | 4.1-4.4 | 3.1 | 3.2 |
| Br1/Br2-[B]H6 | N^{b} | N^{b} | N^{b} | 3.4-4.2 | 3.2-4.5 | 3.2-3.3 | N^{b} |
| Br3/Br4-[B]H6 | 4.7 | 4.6 | 3.4-3.8 | 4.1-4.4 | 4.6-4.7 | 3.5-4.0 | 2.8-3.1 |
| Br3/Br4-[B]H5 | N^{b} | 4.6 | 3.9 | 4.2 | 4.5 | 3.4 | 3.6 |
| Br3/Br4-[A]H6 | 3.1-4.4 | 3.4-3.6 | 3.9-4.7 | N^{b} | N^{b} | N^{b} | 3.2-3.4 |

^{a}Short distance means the distance between two atoms <5 Å.
^{b}N means no interaction between two atoms.

TABLE 5
Crystallographic data for the complexes formed between β-CD and [AuBr₄]⁻ before and after adding additives

| Complex | KAuBr₄⊂β-CD | KAuBr₄•DBC⊂2β-CD | KAuBr₄•2(iPr₂O)⊂2β-CD |
|---|---|---|---|
| Empirical formula | C₄₂H₇₀O₃₅•KAuBr₄•4(H₂O) | 2(C₄₂H₇₀O₃₅)•HAuBr₄•C₁₂H₂₆O₃•14(H₂O) | 2(C₄₂H₇₀O₃₅)•HAuBr₄•2(C₆H₁₄O)•8(H₂O) |
| Formula weight | 1762.75 | 3258.11 | 3136.04 |
| T/K | 100.07(16) | 100.15 | 99.9(3) |
| Crystal system | monoclinic | triclinic | triclinic |
| Space group | P2₁ | P1 | P1 |
| a/Å | 14.90540(10) | 15.11370(18) | 15.1182(8) |
| b/Å | 15.43740(10) | 15.50618(18) | 15.3034(9) |
| c/Å | 14.91910(10) | 15.7047(2) | 15.5384(8) |
| α/° | 90 | 88.8635(10) | 87.704(4) |
| β/° | 119.3100(10) | 81.9417(10) | 81.920(4) |
| γ/° | 90 | 77.0250(10) | 76.368(5) |
| V/Å³ | 2993.43(4) | 3550.84(8) | 3458.9(3) |
| Z | 2 | 1 | 1 |
| ρ_{calcd}/g cm⁻³ | 1.956 | 1.524 | 1.506 |
| μ/mm⁻¹ | 9.299 | 4.205 | 2.322 |
| F (000) | 1760 | 1686.0 | 1620.0 |
| goodness- | 1.067 | 1.068 | 1.017 |
| of-fit on F² | | | |
| Rₗ [I > 2σ (I)] | 0.0270 | 0.0818 | 0.1437 |
| wR₂ [all data] | 0.0711 | 0.2238 | 0.3894 |
| CCDC No. | 2206843 | 2206844 | 2206845 |

| Complex | 0.5(HAuBr₄)⊂2β-CD |
|---|---|
| Empirical formula | 2(C₄₂H₇₀O₃₅)•0.5(HAuBr₄)•23(H₂O) |
| Formula weight | 2943.12 |
| T/K | 100.0(3) |
| Crystal system | monoclinic |
| Space group | P2₁ |
| a/Å | 15.7110(7) |
| b/Å | 24.3931(7) |
| c/Å | 18.9812(7) |
| α/° | 90 |
| β/° | 108.544(4) |
| γ/° | 90 |
| V/Å³ | 6896.7(5) |
| Z | 2 |
| ρ_{calcd}/g cm⁻³ | 1.417 |
| μ/mm⁻¹ | 1.228 |
| F (000) | 3088.0 |
| goodness- | 1.208 |
| of-fit on F² | |
| Rₗ [I > 2σ (I)] | 0.1150 |
| wR₂ [all data] | 0.3237 |
| CCDC No. | 2206846 |

### ¹H NMR Titration

¹H NMR Titrations were performed in D₂O containing 0.5 M DBr at 25° C. Aliquots from a stock solution containing the appropriate amount of KAuBr₄, K₂PdBr₄, or K₂PtBr₄ were added sequentially to an NMR tube containing the β-CD or γ-CD, and a ¹H NMR spectrum was acquired after each addition. The titration isotherms were fitted to a 1:1 receptor-substrate binding model using Thordarson's equations.⁶¹

### UV-Vis Absorption Spectroscopy

The concentrations of [AuBr₄]⁻ in aqueous solutions were determined by UV-Vis absorption spectroscopy employing the absorbance of [AuBr₄]⁻ at λ=381 or 253 nm. The intensity of the UV-Vis absorption band at λ=381 nm correlates linearly with the concentration of [AuBr₄]⁻ over the range from 50 to 150 μM in H₂O with R²=0.999. The intensity of the UV-Vis absorption band at λ=253 nm correlates linearly with the concentration of [AuBr₄]⁻ over the range from 2 to 10 μM in H₂O with R²=0.999.

### ICP-MS Analysis

Quantification of gold (Au) was accomplished using ICP-MS on acidified samples. Specifically, samples (100 μL) designated for Au analysis were digested in 10 mL 2.0% HNO₃ and 2.0% HCl (v/v) aqueous solution. A quantitative standard was made using a 100 μg/mL Au elemental standard (Inorganic Ventures, Christiansburg, VA, USA), which was used to create a 100 ng/g Au standard in 2.0% HNO₃ and 2.0% HCl (v/v) in a total sample volume of 50 mL. A solution of 2.0% HNO₃ and 2.0% HCl (v/v) was used as the calibration blank. All the gold-recovery experiments were independently duplicated. Tables 6 and 7 show one set of data. The average gold-recovery efficiencies with standard deviations are presented in FIG. 5g.

TABLE 6
Effect of changes in concentration of [AuBr₄]⁻ on the
efficiency of recovering gold from mixture solution

| Concentration of | Avg. Au/ | Au in Filtrate/ | Total Au/ | Au-Recovery |
|---|---|---|---|---|
| [AuBr₄]⁻/mM | ppb | μg | μg | Efficiency |
| 0.005 | 34.901 | 0.873 | 0.928 | 0.060 |
| 0.01 | 36.380 | 0.910 | 1.856 | 0.510 |
| 0.025 | 22.983 | 0.575 | 4.640 | 0.876 |
| 0.05 | 24.123 | 0.603 | 9.280 | 0.935 |
| 0.075 | 30.130 | 0.753 | 13.920 | 0.946 |
| 0.1 | 42.046 | 1.051 | 18.559 | 0.943 |
| 0.25 | 43.627 | 1.091 | 46.399 | 0.976 |
| 0.5 | 23.450 | 0.586 | 92.797 | 0.994 |
| 0.75 | 36.907 | 0.923 | 139.196 | 0.993 |
| 1 | 48.028 | 1.201 | 185.594 | 0.994 |

TABLE 7
Changes in the efficiency of recovering gold from mixture solution
with respect to adding different additives in real time

| Different | Avg. Au/ | Au in Filtrate/ | Total Au/ | Au-Recovery |
|---|---|---|---|---|
| Additives | ppb | μg | μg | Efficiency |
| Hexane | 398.941 | 7.979 | 774.014 | 0.990 |
| Benzene | 130.093 | 2.602 | 774.014 | 0.997 |
| Chloroform | 117.617 | 2.352 | 774.014 | 0.997 |
| Dichloromethane | 509.513 | 10.190 | 774.014 | 0.987 |
| Toluene | 22.016 | 0.440 | 774.014 | 0.999 |
| Isopropyl Ether | 188.471 | 3.769 | 774.014 | 0.995 |
| Dibutyl Carbitol | 59.700 | 1.194 | 774.014 | 0.998 |

### Theoretical Calculations

### (1) Visualization of Noncovalent Interaction

Independent gradient model (IGM) analysis is an approach⁶² based on promolecular density an electron density model prior to molecule formation—to identify and isolate intermolecular interactions. Strong polar attractions and Van der Waals contacts are visualized as an iso-surface. Single-crystal superstructures were used as input files. The binding surface was calculated using the Multiwfn 3.6 program⁶³ through function 20 (visual study of weak interaction) and visualized by Chimera software⁶⁴.

### (2) Binding Energy

The superstructures from the single-crystal X-ray diffraction were used for the density functional theory (DFT) calculations in the Orca program⁶⁵ (version 4.1.2) using the hybrid generalized gradient approximation (GGA) Becke three-parameter Lee-Yang-Parr⁶⁶ (B3LYP) functional, the Ahlrich's double zeta basis set with a polarization function⁶⁷ Def2-SVP, and Grimme's third generation atom-pairwise dispersion correction with Becke Johnson damping⁶⁸ (D3BJ); an integration grid of four was used throughout. To further speed up the DFT optimizations, the Coulomb integral and numerical chain-of-sphere integration for the HF exchange^{69,70} (RIJCOSX) method was applied with the Def2/J auxiliary basis⁷¹. All calculations were single points and ran in vacuum. The binding energies were computed as ΔE_{b}=products−reactants, where products are the complexes and the reactants are the individual molecules and ions.

TABLE 8
Results of DFT calculation for the binding energies
in HAuBr₄•DBC⊂2β-CD cocrystal

| | | Binding |
|---|---|---|
| | Electronic | Energy |
| | Energy | ΔE_{b}/kcal |
| Entry | E_{DFT}/Hartree | mol⁻¹ |
| [AuBr₄]⁻ . . . [β-CD]-2 | −14700.19637 | −32.44 |
| [AuBr₄]⁻ . . . [β-CD]-3 | −14700.20786 | −39.64 |
| [β-CD]-2 . . . [AuBr₄]⁻ . . . [β-CD]-3 | −18969.56797 | −93.03 |
| [AuBr₄]⁻ . . . DBC-1 | −11128.27065 | −8.32 |
| [AuBr₄]⁻ . . . DBC-2 | −11128.27038 | −8.15 |
| DBC-1 . . . [AuBr₄]⁻ . . . DBC-2 | −11825.67981 | −16.10 |
| DBC-1 . . . [β-CD]-1 | −4966.737547 | −35.61 |
| DBC-1 . . . [β-CD]-2 | −4966.720184 | −30.37 |
| [β-CD]-1 . . . DBC-1 . . . [β-CD]-2 | −9236.132379 | −110.79 |
| [β-CD]-2 . . . [β-CD]-3 (Primary faces) | −8538.596235 | −23.32 |
| [β-CD]-1 . . . [β-CD]-2 (Secondary faces) | −8538.634395 | −47.27 |
| [AuBr₄]⁻ . . . [β-CD]-1 . . . DBC-1 | −15397.60983 | −42.92 |
| [AuBr₄]⁻ . . . [β-CD]-2 . . . DBC-1 | −15397.65162 | −74.80 |
| [AuBr₄]⁻ . . . [β-CD]-2 . . . [β-CD]-3 . . . | −19667.0234 | −129.85 |
| DBC-1 | | |
| [AuBr₄]⁻ . . . [β-CD]-2 . . . [β-CD]-3 . . . | −20364.48552 | −170.87 |
| DBC-1 . . . DBC-2 | | |

TABLE 9
Results of DFT calculation for the binding energies
in HAuBr₄•2(iPr₂O)⊂2β-CD cocrystal

| | | Binding |
|---|---|---|
| | Electronic | Energy |
| | Energy | ΔE_{b}/kcal |
| Entry | E_{DFT}/Hartree | mol⁻¹ |
| [AuBr₄]⁻ . . . [β-CD]-1 | −14700.15893 | −32.47 |
| [AuBr₄]⁻ . . . [β-CD]-2 | −14700.24900 | −32.74 |
| [β-CD]-1 . . . [AuBr₄]⁻ . . . [β-CD]-2 | −18969.58363 | −84.15 |
| [AuBr₄]⁻ . . . iPr₂O-1 | −10742.54258 | −3.96 |
| [AuBr₄]⁻ . . . iPr₂O-2 | −10742.52625 | −7.18 |
| iPr₂O-1 . . . [AuBr₄]⁻ . . . iPr₂O-2 | −11054.21382 | −10.82 |
| iPr₂O-1 . . . [β-CD]-1 | −4580.967062 | −20.45 |
| [β-CD]-1 . . . [β-CD]-2 (Primary faces) | −8538.63553 | −25.42 |
| [β-CD]-2 . . . [β-CD]-3 (Secondary faces) | −8538.656367 | −38.49 |
| [AuBr₄]⁻ . . . [β-CD]-1 . . . iPr₂O-1 | −15011.87652 | −54.94 |

TABLE 10
Results of DFT calculation for the binding energies
in 0.5HAuBr₄⊂2β-CD cocrystal

| | | Binding |
|---|---|---|
| | Electronic | Energy |
| | Energy | ΔE_{b}/kcal |
| Entry | E_{DFT}/Hartree | mol⁻¹ |
| [AuBr₄]⁻ . . . [β-CD]-1 | −14700.16752 | −35.97 |
| [AuBr₄]⁻ . . . [β-CD]-2 | −14700.16005 | −29.21 |
| [β-CD]-1 . . . [AuBr₄]⁻ . . . [β-CD]-2 | −18969.54003 | −82.46 |
| [β-CD]-1 . . . [β-CD]-2 (Primary faces) | −8538.630479 | −23.17 |
| [β-CD]-2 . . . [β-CD]-3 (Secondary faces) | −8538.638149 | −27.98 |

### REFERENCES

ADDIN EN.REFLIST 1. Brody, H. Gold. Nature 495, S1 (2013).
2. Chen, Y. S., Hong, M. Y., Huang, G. S. A protein transistor made of an antibody molecule and two gold nanoparticles. Nat Nanotechnol 7, 197-203 (2012).
3. Weintraub, K. Biomedicine: The new gold standard. Nature 495, S14-16 (2013).
4. Zhong, D., Franke, J. H., Podiyanachari, S. K., Blomker, T., Zhang, H., Kehr, G., Erker, G., Fuchs, H., Chi, L. Linear alkane polymerization on a gold surface. Science 334, 213-216 (2011).
5. McGivney, E., Gao, X., Liu, Y., Lowry, G. V., Casman, E., Gregory, K. B., VanBriesen, J. M., Avellan, A. Biogenic cyanide production promotes dissolution of gold nanoparticles in soil. Environ. Sci. Technol. 53, 1287-1295 (2019).
6. Veiga, M. M., Nunes, D., Klein, B., Shandro, J. A., Velasquez, P. C., Sousa, R. N. Mill leaching: A viable substitute for mercury amalgamation in the artisanal gold mining sector? J. Clean. Prod. 17, 1373-1381 (2009).
7. Chen, Y., Qiao, Q., Cao, J., Li, H., Bian, Z. Precious metal recovery. Joule 5, 3097-3115 (2021).
8. Burdinski, D., Blees, M. H. Thiosulfate- and thiosulfonate-based etchants for the patterning of gold using microcontact printing. Chem. Mater. 19, 3933-3944 (2007).
9. Cho, E. C., Xie, J., Wurm, P. A., Xia, Y. Understanding the role of surface charges in cellular adsorption versus internalization by selectively removing gold nanoparticles on the cell surface with a I₂/KI etchant. Nano. Lett. 9, 1080-1084 (2009).
10. Doidge, E. D., Carson, I., Tasker, P. A., Ellis, R. J., Morrison, C. A., Love, J. B. A simple primary amide for the selective recovery of gold from secondary resources. Angew. Chem. Int. Ed. 55, 12436-12439 (2016).
11. Lee, H., Molstad, E., Mishra, B. Recovery of gold and silver from secondary sources of electronic waste processing by thiourea leaching. JOM 70, 1616-1621 (2018).
12. Li, F., Zhu, J., Sun, P., Zhang, M., Li, Z., Xu, D., Gong, X., Zou, X., Geim, A. K., Su, Y., Cheng, H. M. Highly efficient and selective extraction of gold by reduced graphene oxide. Nat. Commun. 13, 4472 (2022).
13. Chen, Y., Xu, M., Wen, J., Wan, Y., Zhao, Q., Cao, X., Ding, Y., Wang, Z. L., Li, H., Bian, Z. Selective recovery of precious metals through photocatalysis. Nat. Sustain. 4, 618-626 (2021).
14. Lin, W., Zhang, R. W., Jang, S. S., Wong, C. P., Hong, J. I. “Organic aqua regia”-Powerful liquids for dissolving noble metals. Angew. Chem. Int. Ed. 49, 7929-7932 (2010).
15. Yue, C., Sun, H., Liu, W. J., Guan, B., Deng, X., Zhang, X., Yang, P. Environmentally benign, rapid, and selective extraction of gold from ores and waste electronic materials. Angew. Chem. Int. Ed. 56, 9331-9335 (2017).
16. Mon, M., Ferrando-Soria, J., Grancha, T., Fortea-Perez, F. R., Gascon, J., Leyva-Perez, A., Armentano, D., Pardo, E. Selective gold recovery and catalysis in a highly flexible methionine-decorated metal-organic framework. J. Am. Chem. Soc. 138, 7864-7867 (2016).
17. Sun, D. T., Gasilova, N., Yang, S., Oveisi, E., Queen, W. L. Rapid, selective extraction of trace amounts of gold from complex water mixtures with a metal-organic framework (MOF)/polymer composite. J. Am. Chem. Soc. 140, 16697-16703 (2018).
18. Yang, F., Yan, Z., Zhao, J., Miao, S., Wang, D., Yang, P. Rapid capture of trace precious metals by amyloid-like protein membrane with high adsorption capacity and selectivity. J. Mater. Chem. A. 8, 3438-3449 (2020).
19. Hong, Y., Thirion, D., Subramanian, S., Yoo, M., Choi, H., Kim, H. Y., Stoddart, J. F., Yavuz, C. T. Precious metal recovery from electronic waste by a porous porphyrin polymer. Proc. Natl. Acad. Sci. U.S.A. 117, 16174-16180 (2020).
20. Hong, Y., Rozyyev, V., Yavuz, C. T. Alkyl-linked porphyrin porous polymers for gas capture and precious metal adsorption. Small Sci. 1, 2000078 (2021).
21. Dong, C. C., Xiang, J. F., Xu, L. J., Gong, H. Y. MCl₄ⁿ⁻ (AuCl₄⁻, PtCl₄²⁻, or PdCl₄²⁻) anion extraction from NanMC14 in water using a tetraimidazolium macrocyclic receptor. Tetrahedron Lett. 59, 264-267 (2018).
22. Kinsman, L. M. M., Ngwenya, B. T., Morrison, C. A., Love, J. B. Tuneable separation of gold by selective precipitation using a simple and recyclable diamide. Nat. Commun. 12, 6258 (2021).
23. Shaffer, C. C., Liu, W., Oliver, A. G., Smith, B. D. Supramolecular paradigm for capture and co-precipitation of gold(III) coordination complexes. Eur. J. Chem. 27, 751-757 (2021).
24. O'Connell-Danes, J. G., Ngwenya, B. T., Morrison, C. A., Love, J. B. Selective separation of light rare-earth elements by supramolecular encapsulation and precipitation. Nat. Commun. 13, 4497 (2022).
25. Harada, A., Takahashi, S. Preparation and properties of cyclodextrin-ferrocene inclusion complexes. J. Chem. Soc., Chem. Commun., 645-646 (1984).
26. Colquhoun, H. M., Stoddart, J. F., Williams, D. J. Second-sphere coordination-A novel role for molecular receptors. Angew. Chem. Int. Ed. Engl. 25, 487-507 (1986).
27. Werner, A. Neuere Anschauungen Auf Dem Gebiete Der Anorganischen Chemie, Vieweg: Braunschweig, (1913).
28. Lehn, J. M. Supramolecular chemistry—Scope and perspectives molecules, supermolecules, and molecular devices. (Nobel lecture). Angew. Chem. Int. Ed. Engl. 27, 89-112 (1988).
29. Pedersen, C. J. The discovery of crown ethers. (Noble lecture). Angew. Chem. Int. Ed. Engl. 27, 1021-1027 (1988).
30. Cram, D. J. The design of molecular hosts, guests, and their complexes. (Nobel lecture). Angew. Chem. Int. Ed. Engl. 27, 1009-1020 (1988).
31. Yu, G., Jie, K., Huang, F. Supramolecular amphiphiles based on host-guest molecular recognition motifs. Chem. Rev. 115, 7240-7303 (2015).
32. Steed, J. W. First- and second-sphere coordination chemistry of alkali metal crown ether complexes. Coord. Chem. Rev. 215, 171-221 (2001).
33. Liu, Z., Schneebeli, S. T., Stoddart, J. F. Second-sphere coordination revisited. Chimia 68, 315-320 (2014).
34. Liu, W., Das, P. J., Colquhoun, H. M., Stoddart, J. F. Whither second-sphere coordination? CCS Chem. 4, 755-784 (2022).
35. Harada, A., Takahashi, S. Preparation and properties of inclusion compounds of transition metal complexes of cyclo-octa-1,5-diene and norbornadiene with cyclodextrins. J. Chem. Soc., Chem. Commun., 1229-1230 (1986).
36. Prochowicz, D., Kornowicz, A., Lewinski, J. Interactions of native cyclodextrins with metal ions and inorganic nanoparticles: Fertile landscape for chemistry and materials science. Chem. Rev. 117, 13461-13501 (2017).
37. Beer, P. D., Drew, M. G. B., Ogden, M. I. First- and second-sphere coordination of a lanthanum cation by a calix[4]arene tetraamide in the partial-cone conformation. J. Chem. Soc., Dalton Trans., 1489-1492 (1997).
38. Chen, L. X., Liu, M., Zhang, Y. Q., Zhu, Q. J., Liu, J. X., Zhu, B. X., Tao, Z. Outer surface interactions to drive cucurbit[8]uril-based supramolecular frameworks: Possible application in gold recovery. Chem. Commun. 55, 14271-14274 (2019).
39. Liu, W., Oliver, A. G., Smith, B. D. Macrocyclic receptor for precious gold, platinum, or palladium coordination complexes. J. Am. Chem. Soc. 140, 6810-6813 (2018).
40. Nelson, J. J. M., Schelter, E. J. Sustainable inorganic chemistry: Metal separations for recycling. Inorg. Chem. 58, 979-990 (2019).
41. Bender, T. A., Bergman, R. G., Raymond, K. N., Toste, F. D. A supramolecular strategy for selective catalytic hydrogenation independent of remote chain length. J. Am. Chem. Soc. 141, 11806-11810 (2019).
42. Luis, E. T., Day, A. I., Konig, B., Beves, J. E. Photophysical activity and host-guest behavior of ruthenium polypyridyl catalysts encapsulated in cucurbit[10]uril. Inorg. Chem. 59, 9135-9142 (2020).
43. Simke, J., Bockermann, T., Bergander, K., Klabunde, S., Hansen, M. R., Ravoo, B. J. Photoresponsive host-guest chemistry and relaxation time of fluorinated cyclodextrin and arylazopyrazole-functionalized DOTA metal complexes. Org. Biomol. Chem. 19, 2186-2191 (2021).
44. Thuery, P. Lanthanide complexes with cucurbit[n]urils (n=5, 6, 7) and perrhenate ligands: New examples of encapsulation of perrhenate anions. Inorg. Chem. 48, 4497-4513 (2009).
45. Ji, X., Chi, X., Ahmed, M., Long, L., Sessler, J. L. Soft materials constructed using calix[4]pyrrole- and “Texas-sized” box-based anion receptors. Acc. Chem. Res. 52, 1915-1927 (2019).
46. Chen, L. J., Berry, S. N., Wu, X., Howe, E. N. W., Gale, P. A. Advances in anion receptor chemistry. Chem 6, 61-141 (2020).
47. Zhao, W., Flood, A. H., White, N. G. Recognition and applications of anion-anion dimers based on anti-electrostatic hydrogen bonds (AEHBs). Chem. Soc. Rev. 49, 7893-7906 (2020).
48. Katayev, E. A., Boev, N. V., Khrustalev, V. N., Ustynyuk, Y. A., Tananaev, I. G., Sessler, J. L. Bipyrrole- and dipyrromethane-based amido-imine hybrid macrocycles. New receptors for oxoanions. J. Org. Chem. 72, 2886-2896 (2007).
49. Ni, X. L., Xiao, X., Cong, H., Zhu, Q. J., Xue, S. F., Tao, Z. Self-assemblies based on the “outer-surface interactions” of cucurbit[n]urils: New opportunities for supramolecular architectures and materials. Acc. Chem. Res. 47, 1386-1395 (2014).
50. Wu, H., Wang, Y., Jones, L. O., Liu, W., Zhang, L., Song, B., Chen, X. Y., Stern, C. L., Schatz, G. C., Stoddart, J. F. Selective separation of hexachloroplatinate(IV) dianions based on exo-binding with cucurbit[6]uril. Angew. Chem. Int. Ed. 60, 17587-17594 (2021).
51. Fang, X., Kogerler, P., Isaacs, L., Uchida, S., Mizuno, N. Cucurbit[n]uril-polyoxoanion hybrids. J. Am. Chem. Soc. 131, 432-433 (2009).
52. Mercer, D. J., Loeb, S. J. Metal-based anion receptors: An application of second-sphere coordination. Chem. Soc. Rev. 39, 3612-3620 (2010).
53. Colquhoun, H. M., Lewis, D. F., Stoddart, J. F., Williams, D. J. Crown ethers as second-sphere ligands. The interactions of transition-metal ammines with 18-crown-6 and dibenzo-18-crown-6. J. Chem. Soc. Dalt. Trans., 607-613 (1983).
54. Liu, Z., Frasconi, M., Lei, J., Brown, Z. J., Zhu, Z., Cao, D., Iehl, J., Liu, G., Fahrenbach, A. C., Botros, Y. Y., Farha, O. K., Hupp, J. T., Mirkin, C. A., Stoddart, J. F. Selective isolation of gold facilitated by second-sphere coordination with α-cyclodextrin. Nat. Commun. 4, 1855 (2013).
55. Liu, Z., Samanta, A., Lei, J., Sun, J., Wang, Y., Stoddart, J. F. Cation-dependent gold recovery with α-cyclodextrin facilitated by second-sphere coordination. J. Am. Chem. Soc. 138, 11643-11653 (2016).
56. Hojo, M., Iwasaki, S., Okamura, K. Pure gold dissolution with hydrogen peroxide as the oxidizer in HBr or HI solution. J. Mol. Liq. 246, 372-378 (2017).
57. Dolomanov, O. V., et al. OLEX2: A complete structure solution, refinement and analysis program. J. Appl. Cryst. 42, 339-341 (2009).
58. Sheldrick, G. M. SHELXT-Integrated space-group and crystal-structure determination. Acta. Cryst. A 71, 3-8 (2015).
59. Sheldrick, G. M. A short history of SHELX. Acta. Cryst. A 64, 112-122 (2008).
60. Thorn, A., Dittrich, B., Sheldrick, G. M. Enhanced rigid-bond restraints. Acta. Cryst. A 68, 448-451 (2012)
61. Thordarson, P. Determining association constants from titration experiments in supramolecular chemistry. Chem. Soc. Rev. 40, 1305-1323 (2011)
62. Lefebvre, C., et al. Accurately extracting the signature of intermolecular interactions present in the NCI plot of the reduced density gradient versus electron density. Phys. Chem. Chem. Phys. 19, 17928-17936 (2017).
63. Lu, T., Chen, F. Multiwfn: A multifunctional wavefunction analyzer. J. Comput. Chem. 33, 580-592 (2012).
64. Pettersen, E. F., et al. UCSF Chimera-A visualization system for exploratory research and analysis. J. Comput. Chem. 25, 1605-1612 (2004).
65. Neese, F. The ORCA program system. Wiley Interdiscip. Rev.: Comput. Mol. Sci. 2, 73-78 (2012).
66. Becke, A. D. Density functional thermochemistry III. The Role of exact exchange. J. Chem. Phys. 98, 5648-5652 (1993).
67. Weigend, F., Ahlrichs, R. Balanced basis sets of split valence, triple zeta valence and quadruple zeta valence quality for H to Rn: Design and assessment of accuracy. Phys. Chem. Chem. Phys. 7, 3297-3305 (2005).
68. Grimme, S., Ehrlich, S., Goerigk, L. Effect of the damping function in dispersion corrected density functional theory. J. Comp. Chem. 32, 1456-1465 (2011).
69. Neese, F. An improvement of the resolution of the identity approximation for the calculation of the Coulomb matrix. J. Comp. Chem. 24, 1740-1747 (2003).
70. Izsák, R.; Neese, F. An overlap fitted chain of spheres exchange method. J. Chem. Phys. 135, 144105 (2011).
71. Weigend, F. Accurate Coulomb-fitting basis sets for H to Rn. Phys. Chem. Chem. Phys. 8, 1057-1065 (2006).

1. An adduct formed from a cyclodextrin, a gold halide anion, and an additive, wherein the gold halide anion occupies a space between primary faces of the cyclodextrin and the additive occupies a space between secondary faces of the cyclodextrin and/or within an internal cavity of the cyclodextrin.

2. The addict of claim 1, wherein cyclodextrin tori are arranged in a head-to-head and tail-to-tail manner extending along an axis and forming a one-dimensional supramolecular polymer.

3. The adduct of claim 1, wherein the gold halide anion is [AuBr₄]⁻ or the cyclodextrin is β-cyclodextrin.

4. The adduct of claim 1, wherein the gold halide anion is [AuBr₄]⁻ and the cyclodextrin is β-cyclodextrin.

5. The adduct of claim 1, wherein the additive is hydrophobic and has a binding affinity for the cyclodextrin.

6. The adduct of claim 5, wherein the additive is size-matched to the cavity of the cyclodextrin.

7. The adduct of claim 5, wherein the additive has a boiling point above 50° C.

8. The adduct of claim 5, wherein the additive is selected from an ether, an arene, an alkylarene, a haloalkane, or an alkane.

9. The adduct of claim 5, wherein the additive is selected from dibutyl carbitol, isopropyl ether, benzene, toluene, chloroform, dichloromethane, or hexane.

10. The adduct of claim 5, wherein the additive is dibutyl carbitol.

11. A method for preparing an adduct comprising contacting a cyclodextrin, a gold halide anion, and an additive in solution.

12. The method of claim 11, wherein the additive is added to a solution comprising the cyclodextrin and gold halide anion.

13. The method of claim 12, wherein the additive is added to the solution at a percentage between 0.05% v/v and 5.0% v/v, optionally between 0.05% v/v and 0.5% v/v.

14. The method of claim 12, wherein the molar ratio of cyclodextrin to gold halide anion is between 0.5 and 5.0, optionally between 2.0 and 3.0.

15. The method of claim 12, wherein the concentration of gold halide anion is between 0.01 mM and 5.0 mM, optionally between 0.05 mM and 2.0 mM.

16. The method of claim 12, wherein the additive is added to the solution at a percentage between 0.05% v/v and 5.0% v/v, optionally between 0.05% v/v and 0.5% v/v; wherein the molar ratio of cyclodextrin to gold halide anion is between 0.5 and 5.0, optionally between 2.0 and 3.0; and wherein the concentration of gold halide anion is between 0.01 mM and 5.0 mM, optionally between 0.05 mM and 2.0 mM.

17. A method for recovering gold comprising contacting a gold-bearing material with a hydrogen halide to form a gold halide anion, contacting the gold halide anion with a cyclodextrin and an additive to form an adduct, and reducing the adduct.

18. The method of claim 17, wherein the gold-bearing material is contacted with HBr and H₂O₂.

19. The method of claim 17, wherein the adduct is reduced with N₂H₄·H₂O.

20. The method of claim 17 further comprising recycling the cyclodextrin after reducing the adduct.
